(19) United States
(12) Patent Application Publication
(10) Pub. No.: US 2026/0359365 A1
(43) Pub. Date: Nov. 12, 2026

(54) DYNAMIC RETRIEVAL AND INDEXING FRAMEWORK TECHNOLOGY

(71) Applicant: Genpact USA, Inc., New York, NY (US)

(72) Inventors: Parth Sharma, Ajmer (IN); Yagya Dutt Sharma, Pilani (IN); Tanish Verma, New Delhi (IN); Parimesh Panda, Bangalore (IN); Omprakash Ranakoti, Bangalore (IN); Megha Sinha, Gurgaon (IN); Sreekanth Menon, Bangalore (IN); Aman Kaif Mohammad, Pune (IN)

(21) Appl. No.: 19/200,080

(22) Filed: May 6, 2025

(51) Int. Cl. G06F 16/93

(52) U.S. Cl. CPC G06F 16/93

(57) ABSTRACT

A method and system for generating semantic and unit-length segments based on a dynamic threshold is disclosed. In some embodiments, the method includes receiving an electronic document and dividing the document into semantic segments. The method includes determining that a first segment of the semantic segments includes a large segment, and transforming the first segment into two or more semantic segments. Each of the two or more semantic segments has a size less than the first segment, and the segments are stored in a database. The method also includes receiving a query and retrieving, from the semantic segments stored in the database, a first set of segments. The method further includes reducing, based on a first threshold, the first set of segments to a second set of semantic and unit-length segments for inputting to a model.

### TECHNICAL FIELD

This disclosure relates to domain search and information retrieval, and, in particular, to systems and methods for integrating semantic comprehension into data segmentation when processing queries and utilizing a dynamic threshold mechanism to filter retrieved information.

### BACKGROUND

Existing approaches in the field of data retrieval, particularly in data generation and processing, aim to efficiently manage and generate data (e.g., text). As to data retrieval, creating and maintaining fast, scalable indexes (e.g., vector databases) for retrieving relevant chunks is complex. Different applications require different chunk sizes, making dynamic or adaptive splitting necessary. For example, in a RAG application when text is broken into small data segments or chunks in a data splitting process, information may be fragmented and context may be lost, making it hard for an AI model to understand relationships between data chunks. Other problems include semantic understanding, latency in large datasets, etc. As a result, computational overhead may become a bottleneck, and efficient data splitting and retrieval (e.g., in processing large datasets) without excessive memory or processor usage is challenging.

### SUMMARY

To address the aforementioned shortcomings, a method and a system for generating hybrid (an amalgamation of semantic—unit-length) segments for indexing with data retrieval based on a dynamic filtration threshold are disclosed herein. In some embodiments, the method receives an electronic document and divides the electronic document into semantic segments for storing in a database. To transform a semantic segment into two or more smaller semantic segments, it is determined whether the electronic document includes a table of contents. In response to the table of contents being available, the semantic segment is refined using recursive splitting based on the table of contents. In some embodiments, the electronic document is divided into semantic segments by converting the document into a markdown output to identify structural elements of data and segmenting the document based on markdown section headings. In some embodiments, the present system also creates unit-length chunks (e.g., representing the actual page by page view of electronic document) using custom page-markers added into the markdown document and preforms page-wise mapping between two sets of segments. A unit-length can be defined as a single unit of logical segment from the data. For example, the unit-length is a page for an electronic document, the unit-length is a one-minute clip for a video, while the unit-length for an image can be a single cropped object of the image.

In some embodiments, the method includes receiving, at a computing system comprising a processor and a memory, an electronic document; dividing, by the processor, the electronic document into a plurality of semantic segments; determining, by the processor, that a first semantic segment of the plurality of semantic segments is a large segment; transforming, by the processor, the first semantic segment into two or more semantic segments, each of the two or more semantic segments having a size less than the first semantic segment, and the plurality of semantic segments including the two or more semantic segments being stored in a database; receiving a query; retrieving, by the processor and from the plurality of semantic segments, a first set of semantic segments; and reducing, by the processor and based on a first threshold, the first set of semantic segments to a second set of semantic and unit-length segments for inputting to a model.

In some embodiments, it is determined that the electronic document includes non-textual content, and segmentation is performed on the non-textual content based on tagging the non-textual content and context surrounding the non-textual content. In some embodiments, the non-textual content, included in the electronic document at a particular position of a particular page, is processed, and the processed non-textual content is inserted into one or more of the plurality of semantic segments at the particular position of the particular page based on the tagging.

In some embodiments, the semantic page-wise mapping is performed between the semantic and unit-length segments to map semantic segments to one or more pages of the electronic document.

The above and other preferred features, including various novel details of implementation and combination of elements, will now be more particularly described with reference to the accompanying drawings and pointed out in the claims. It will be understood that the particular methods and apparatuses are shown by way of illustration only and not as limitations. As will be understood by those skilled in the art, the principles and features explained herein may be employed in various and numerous embodiments.

### BRIEF DESCRIPTION OF THE DRAWINGS

The disclosed embodiments have advantages and features that will be more readily apparent from the detailed description, the appended claims, and the accompanying figures (or drawings). A brief introduction of the figures is below.

FIGS. 1A and 1B illustrate an exemplary document segmentation and retrieval process, according to some embodiments.

FIG. 2 illustrates an exemplary functional diagram for segmenting and retrieving data, according to some embodiments.

FIGS. 3A-3F illustrate an exemplary process of semantic page-wise chunking, according to some embodiments.

FIGS. 4A and 4B illustrate an exemplary process related to TOC-controlled chunking, according to some embodiments.

FIG. 4C illustrates an exemplary flow diagram of a custom retriever for processing large segments, according to some embodiments.

FIGS. 5A and 5B illustrate an exemplary image segmentation process, according to some embodiments.

FIGS. 6A-6C illustrate an exemplary dynamic thresholding process, according to some embodiments.

FIG. 7 illustrate an example flowchart of generating semantic segments for data retrieval based on a dynamic threshold, according to some embodiments.

FIG. 8 illustrates a block diagram of an example computer system that may be used in implementing the technology described herein, according to some embodiments.

### DETAILED DESCRIPTION

The Figures (FIGS.) and the following description relate to preferred embodiments by way of illustration only. It should be noted that from the following discussion, alternative embodiments of the structures and methods disclosed herein will be readily recognized as viable alternatives that may be employed without departing from the principles of what is claimed.

Reference will now be made in detail to several embodiments, examples of which are illustrated in the accompanying figures. It is noted that wherever practicable similar or like reference numbers may be used in the figures and may indicate similar or like functionality. The figures depict embodiments of the disclosed system (or method) for purposes of illustration only. One skilled in the art will readily recognize from the following description that alternative embodiments of the structures and methods illustrated herein may be employed without departing from the principles described herein.

### Existing Data Segment and Retrieval Technologies

Existing text splitting approaches include a character text splitter, a recursive character text splitter, a markdown header splitter, etc. The character text splitter approach includes dividing text into smaller segments or chunks based on a fixed number of characters. This approach is straightforward and ensures that the text is evenly distributed for processing (e.g., page by page). However, a significant problem associated with the character text splitter is the potential loss of context, especially when the content spans multiple pages or contains complex narratives. The arbitrary splitting may disrupt the flow of information, making it challenging for query engines to fetch coherent and contextually relevant information. For example, words may be cut in half, and sentences may be split in the middle, leading to loss of context in structured data.

The recursive character text splitter is an improved version of the character text splitter that aims to preserve contextual meaning while breaking text into segments or chunks. In addition to dividing textual content according to a predetermined character count threshold, the recursive character text splitter includes a recursive analysis to examine the segments for consistency and contextual integrity. If a segment is deemed to be devoid of narrative organization or coherent progression, the algorithm of recursive character text splitter is designed to recalculate the split such that the split point can be repositioned in closer proximity to punctuation marks or semantic boundaries to more effectively maintain the informative content in the segment. This approach enables recursive adjustments based on the text's intrinsic structures and complexities and is widely used in applications with high requirements of readability and logical consistency (e.g., content production, construction of interactive computing platforms, etc.). In reality, however, even if the recursive character text splitter aims to maintain context, it cannot categorically guarantee the contextual integrity in each text segment, particularly when contextual meanings are entangled over long text spans. The computing resources required for recursive analysis and modification may also adversely affect the system processing speed.

On the other hand, the markdown header splitter takes a different tack and uses markdown header tags to divide a document into parts. This approach interprets that text segments split at different header levels as cohesive units based on the semantic coherence assumed in the text. This segmentation technique is applied to preserve the contextual and logical flow inside each segment, which is especially useful for processing well-structured documents that use headers to denote different sections or subjects.

The effectiveness of markdown header splitters, however, relies heavily on proper markdown formatting, limiting its applicability to certain types of publications. Due to such adherence to header-based segmentation, under-segmentation in documents with inadequate header usage or excessive fragmentation in overly structured texts may arise, leading to too large segments or too granular segments. Unlike the recursive character text splitter, which can dynamically adjust split points based on content attributes, the markdown header splitter depends solely on predefined structural markers. This fixed segmentation approach may not always align with optimal split points for logical or semantic division, making it less suitable for handling diverse text formats.

While the segmented text is optimized for processing and context is preserved within computing environments, especially in structured documents (e.g., technical manuals, scholarly articles, and other well-organized texts), the segment in the markdown header splitter cannot be readily mapped to real-world references, such as specific pages or sections in a printed document. This mismatch may create challenges in applications where direct correlation to physical or page-based references is necessary, for example, in contexts requiring precise citations, cross-referencing within physical documents, or in scenarios where users seek to locate the electronic content's analogs in a tangible format.

Given the aforementioned shortcomings, particularly of the markdown header splitter, an important technical consideration in text segmentation algorithms is to balance the benefits of computer-implemented segmentation techniques with the need to maintain direct references to physical locations within documents in broader real-world scenarios. Currently, the markdown header splitter may enhance processing efficiency and context preservation in electronic documents, but its effectiveness is constrained by the requirement for compatibility with traditional page-based navigation and referencing systems.

Other critical technical issues to be addressed by the present system related to data retrieval mechanisms. In general, a data retriever matches the similarity between a query and documents stored in a database and fetches the most similar or relevant documents. For example, a retrieval algorithm, such as Okapi BM25, may generate a retrieval result (e.g., document segments) based on a relevance score computed using an inverse document frequency (IDF), a frequency of a keyword present in a document, a length of the document, etc. Since at least one parameter (e.g., IDF) used to compute the relevance score is determined based on a total number of documents stored in the document corpus or database, the relevance score across the corpus may vary when the corpus varies (e.g., a new document is added to the corpus).

The challenge with variable scores in a variable-expanding document corpus arises when a filter is applied to retrieval results. Since relevance scores are unbounded and can fluctuate significantly (e.g., based on term frequency, document length, etc.), it is typical to set a threshold to retain only high-ranking document segments and ensure relevant search/retrieval outcomes. One method for determining this threshold is through experimentation, where an appropriate value is identified empirically based on a specific use case. However, this threshold becomes obsolete when a new document is added or an existing one is removed from the database, as changes in corpus size impact score distributions.

### Overview

To overcome the aforementioned limitations, disclosed herein is an innovative data retrieval and indexing approach that improves contextual integrity preservation, applies dynamic thresholding for retrieval, enhances referencing mechanisms, etc. The present approach may span across multiple domains and is specifically helpful in an environment requiring high informational accuracy and contextual relevance.

By segmenting a document based on contextual relevance, the present system ensures that the context is maintained across data segments or chunks. This represents a significant advancement over existing methods that rely solely on character count or markdown headers for text splitting and often disrupt narrative flow and context. A semantic segment is a subsection of a document. A semantic segment can sometimes be quite large due to the absence of length constraints for document subsections and/or incomplete demarcations, unstructured data. A large segment refers to a data chunk that exceeds a certain length for a particular use-case (e.g., determined by the maximum data length that can be efficiently processed at one time). For example, a segment may become excessively large when unidentified headers arise during markdown conversion. The present system can optimize efficiency by breaking down the chunk further using the data's structural index or reducing the search space for these large semantic chunks, thereby accelerating processing speed.

In some embodiments, the present system may conduct page-wise mapping to link semantic chunks and unit-length chunks to preserve the relationship between content and its location in data.

Using the page-wise mapping, the present system further incorporates an advanced referencing system that accurately tracks the source of information, allowing for precise citations even when the text is split semantically. This solves a major technical issue faced by other segmentation methods, where accurate reference management is compromised.

The innovative use of dynamic thresholding allows the present system to adapt to changes in a document corpus, ensuring that the retrieval system remains effective when a new document is added or removed. This addresses a key technical challenge where existing thresholding methods may become obsolete as the document corpus evolves.

In general, by selectively processing relevant semantic chunks and calculating thresholds dynamically to improve a retrieval result, the present system improves retrieval accuracy and efficiency while staying within computational limits. This efficiency is vital for maintaining performance, particularly when dealing with extensive datasets or when real-time responses are required. The present system supplies informative, consistent, and contextually relevant data, which is important for applications relying on precise information. The present system is designed to handle diverse document structures, making it more applicable across different domains.

### System Implementation

Data preparation, including data segmentation and data scoring mechanism, plays a crucial role in guaranteeing the efficient storing of data (e.g., in an index) and the effective retrieval of pertinent information. For example, in a retrieval-augmented generation (RAG) pipeline, a document may be split into smaller segments, and then be indexed and retrieved individually. The present system aims to transform the way of data retrieval by incorporating semantic comprehension into a segmentation process. The present system acknowledges the significance of a document structure within a unit-length framework (e.g., page-by-page) and emphasizes the importance of maintaining logical consistency when breaking a document's text into queryable units. By splitting segments based on contextual relevance (semantically), the present system preserves the context that is often lost in traditional text splitting methods. This enhances the quality of the retrieved information, meaning that data retrieval is not only more efficient but also more matched with the natural structure and meaning of source data. By leveraging a dynamic scoring or thresholding mechanism for filtering queried information, the present system ensures that the retrieved content is consistent, tailored to specific queries, and enriched with the most relevant information.

While the description herein is primarily in the context of large language models (LLMs) for clarity and conciseness, it should be noted that the disclosed approach can also be applied to other machine learning and artificial intelligence models.

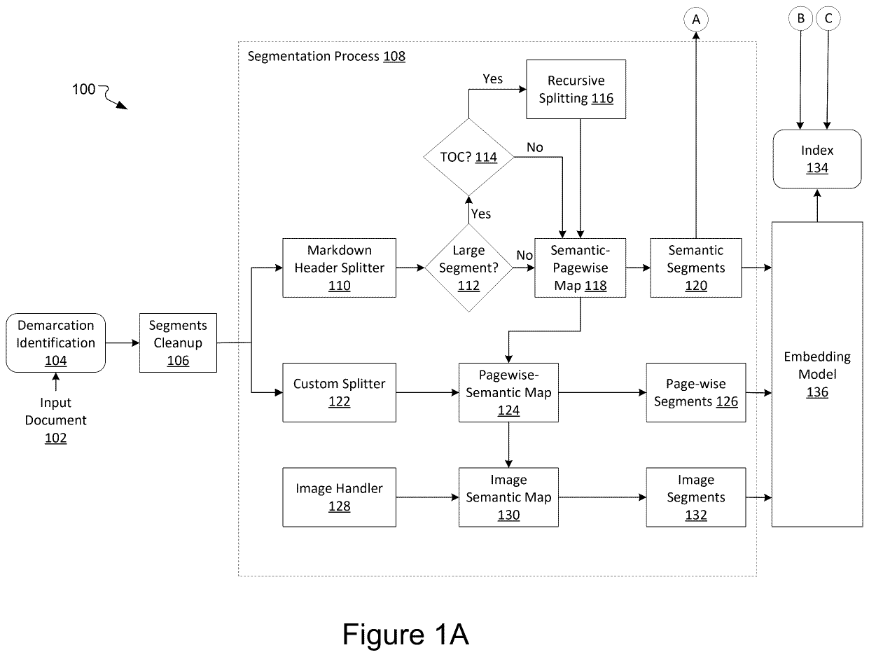

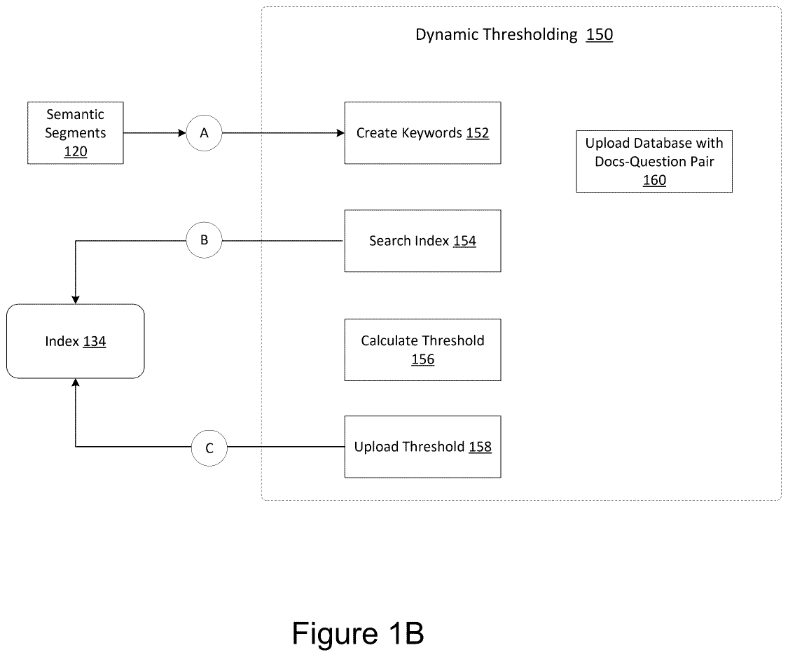

FIGS. 1A and 1B illustrate an exemplary document segmentation and retrieval process, according to some embodiments. FIG. 1A mainly includes a document identification and segmentation process 100. As depicted, an input document 102 is pre-processed at steps 104 and 106 and then entered into a segmenting process, represented by a dashed box 108, to generate semantic segments. The semantic segments are stored in an index for efficient retrieval.

Input document 102 can be an electronic document with text and/or image data. In some embodiments, input document 102 may include structured documents (e.g., technical manuals, academic papers, etc.) with some identification markups such as headings, TOC, etc. Input document 102 is ingested and processed at steps 104 and 106 to prepare for segmentation.

At step 104, the present system analyzes the document's structure to determine how it should be segmented, based on identifying demarcation points (e.g., markers) that define meaningful content divisions. In some embodiments, the present system may scan input document 102 to check structural elements such as section headers and structural index of data. These elements help in creation of semantic chunks 110, and the custom page markers added in markdown go through custom splitter 122 for unit-length segmentation.

At step 106, the present system prepares input document 102 for segmentation by removing unnecessary elements and ensuring clean, structured data, which enhances data clarity and consistency, preventing errors in segmentation and/or retrieval. In some embodiments, the present system may identify and remove unwanted elements, for example, extraneous content such as irrelevant metadata, formatting inconsistencies, non-informative symbols, etc. The present system may also adjust inconsistent capitalization, punctuation, or encoding issues to standardize text formatting.

### Data Segmentation

After cleaning, process 100 moves to a data segmentation process 108. Input document 102 with structural elements (e.g., headers) may be routed to markdown header splitter 110, where the text of input document 102 can be divided into structured chunks based on contextually relevant meaning demarcated by markdown formatting to mitigate the context loss. The structured chunks, referred to as semantic segments, are configured to closely reflect the natural division of content within the document. In some embodiments, the present system may convert input document 102 to a markdown format to identify all headers of the document along with the text using any suitable markdown conversion service. For example, the markdown headers may include a hashtag representing a main title, two hashtags representing a section header, three hashtags representing subsections, etc. The present system may group each header and its associated content of input document 102 into segments and also maintain the hierarchy of nested headers leading to creation of semantic segments.

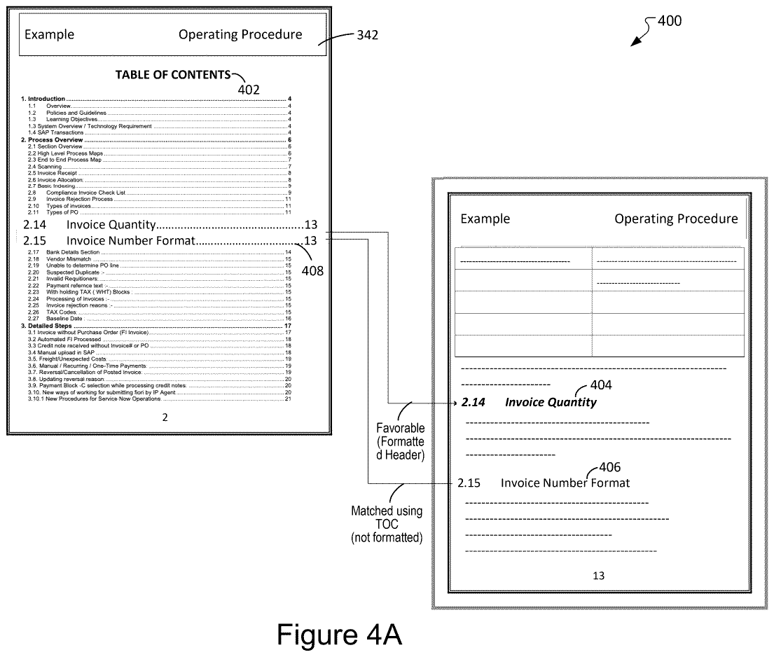

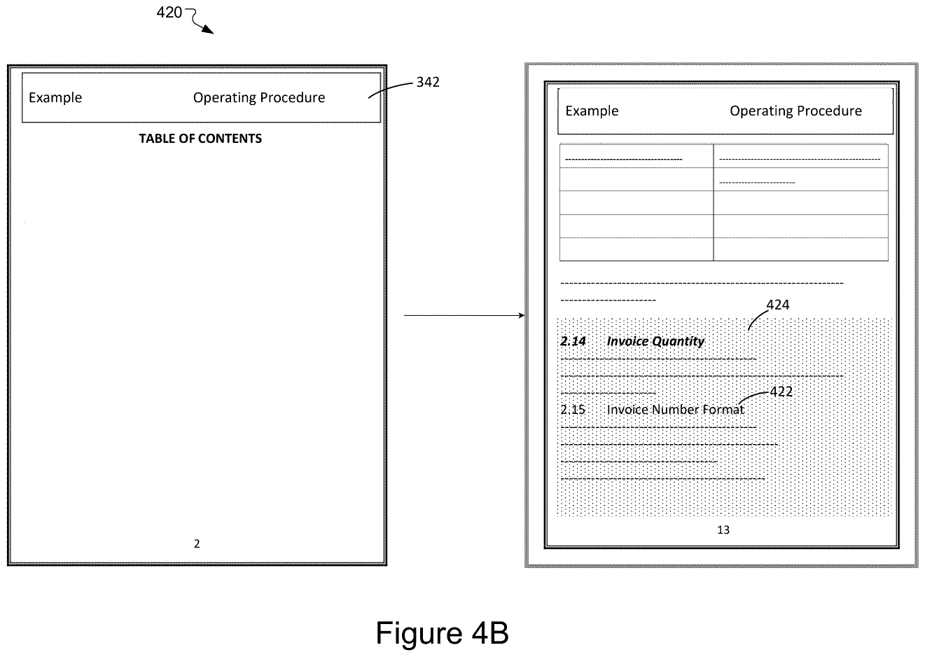

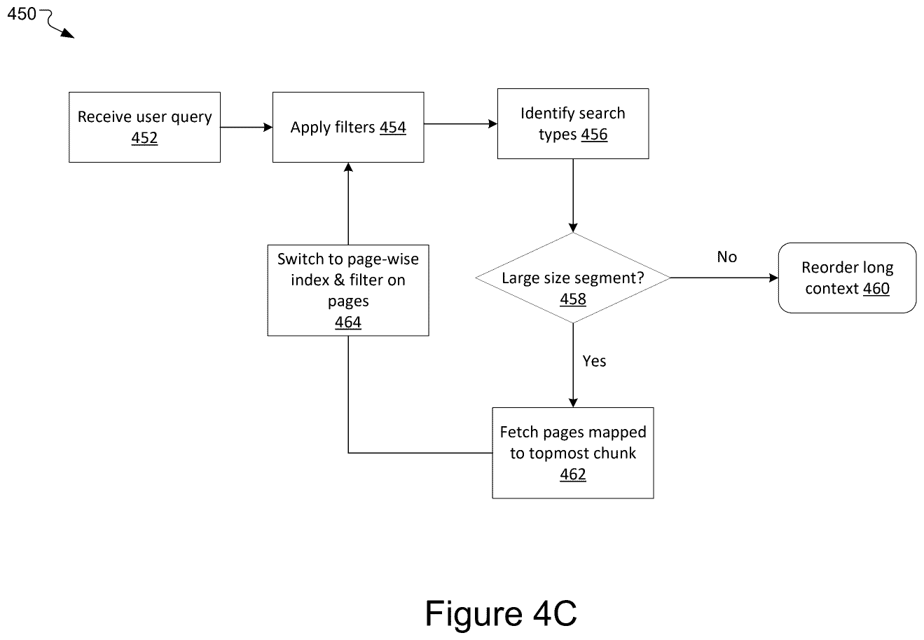

As mentioned above, a semantic chunk obtained from markdown header splitter 110 can be larger than a desired maximum length in a particular use-case. A large-sized or large segment may reduce processing speed and consume excessive computing resources. In the illustrated embodiment of FIG. 1A, the present system determines whether markdown header splitter 110 outputs a large segment at 112. If a large segment is created, the present system flags it for further refinement. At 114, the present system checks if a structural index is available. In some embodiments, the structural index may be a table of contents (TOC) of a document. If the structural index or TOC is available, large semantic segments may be further split using recursive splitting at 116 to reduce their size, until all the headers that align with the TOC have been split upon. The large semantic segment handling will be further described below with reference to FIGS. 4A-4C. However, if no large segment exists at 112 or input document 102 does not include a TOC at 114, the present system continues to perform semantic page-wise map at 118 and store the mapping in the segments' metadata at 120 for further usage.

In some embodiments, the metadata for a semantic segment may include an identifier, a semantic index, a file name, page numbers, etc. Since a semantic segment may be formed from multiple pages of input document 102, the page numbers field in the metadata associated with the semantic segment allows referencing those relevant pages. On the other hand, the metadata for a unit-length (e.g., a single page) segment may include an identifier, a file name, a semantic-index-map, etc. Since a unit-length segment corresponds to a single unit (e.g., page), the semantic-index-map field in its metadata can establish a connection between the unit-length segment and the semantic segment(s) derived from that page. The semantic page-wise mapping is performed in 118. In some embodiments, the semantic chunks along with the mappings are referred to as semantic segments 120.

Assume that Dᵢ is input document 102, one of the documents queried upon by a user. By applying a conversion function ƒ, the present system may convert input document 102 in any document format to a markdown representation (using a suitable markdown converter)Mi in a markdown (.md) format, i.e., ƒ(Di)=Mi. Suppose Mᵢ contains n distinguishable sections demarcated by markdown headers. By performing transformation g, the present system may split down the markdown representation Mᵢ into n semantic segments SCᵢ based on n section headings present in Mᵢ, as shown in step 110.

g(Mᵢ)={SC}ᵢ={SCᵢ₁,SCᵢ₂,SCᵢ₃ . . . SCᵢₙ} or {SC}ᵢ=(g(ƒ(Dᵢ))

The entire transformation from the original document D or input document 102 is a set of semantic segments SCᵢ, and |SCᵢⱼ|∈ [symbol] , since a section of a document cannot be a fixed length, where [symbol] indicates a set of natural numbers.

However, in practice, it is not always guaranteed that every header in a document is correctly identified, and some may be missed during processing. Consider a document Dₘ, where one or more headers are not properly detected during markdown conversion 110, which may lead to a large-sized segment at 112. If it is determined that document Dₘ includes a TOC at 112, the present system may use this TOC to implement a table of content splitting.

Assume nₘ represents the number of headers that were successfully identified. The present system may define TOC as a function that takes in the markdown representation Mₘ of document Dₘ as input and returns a column matrix T_{N×1} as output, where each element corresponds to an entry in the table of contents (TOC) of document Dₘ. If the TOC of document Dₘ contains all the headers present in the document, then N=nₘ, and TOC (Mₘ)=T_{N×1}. Given that not all headers are identified (N>nₘ), the number of segments initially identified by the present system is |{SC}ₘ|=nₘ. However, by leveraging the headers present in T_{N×1}, the present system can locate the missing headers within Mₘ and further refine segment splits to achieve |{SC}ₘ|=N.

An example method for verifying the segments refined based on TOC is described herein. The present system may identify all possible section headers in the markdown representation M using a regular expression function, i.e., regex(Mᵢ)=H_{1×X}, where H_{1×X} is a row matrix containing all detected section headers. Next, the present system may apply a transformation function P, which converts each header string into a vector representation:

T_V_{N×1}=p(T)=[p(tⱼ)]∇j∈[1,N]

H_V_{1×X}=p(H)=[p(hₖ)]∇k∈[1,X]
where tⱼ represents elements from column matrix T, hₖ represents elements from row matrix H, N is the number of elements in TOC, and X is the number of identified headers in text.

To compare these vectors, the present system may compute a cosine distance between each pair of elements from matrices Tv and Hv:

$$cosine distance = c ( X , Y ) = 1 - \frac{( X \cdot Y )}{( ‖ X ‖ ) * ‖ Y ‖ )} ,$$

Let tᵥᵢ be the ith element of Tv and hᵥⱼ be the jth element of H_{V}. The present system may construct a distance matrix:

D_{N×X}=[c(tᵥ_{ᵢ},hᵥ_{ⱼ})]∇i∈{1,2,3 . . . N}∇j∈{1,X}

where N is the number of elements in the TOC, and X is the number of identified headers.

The present system may then obtain a reduced distance matrix by selecting the minimum distance for each header:

$${D\_Reduced}_{N x 1} = [ {min}_{j ∈ \{ 1 , 2 … X \}} ( {x}_{i j} ) ] ∀ i ∈ \{ 1 , 2 … N \}$$

If the frequency of 0's in D_Reduced is high (e.g., above a predefined threshold), it indicates that the document is well-formatted and the TOC aligns with the headers present through the document. As a result, a TOC-based splitting may be performed. The present system may then utilize a recursive splitting algorithm to systematically divide input document 102 into meaningful segments. This algorithm identifies headers in each large segment, splits the segment accordingly, and checks the size of the segment. The present system repeats this process until no further headers are left to split on or until the size of each segment is below a desired size threshold.

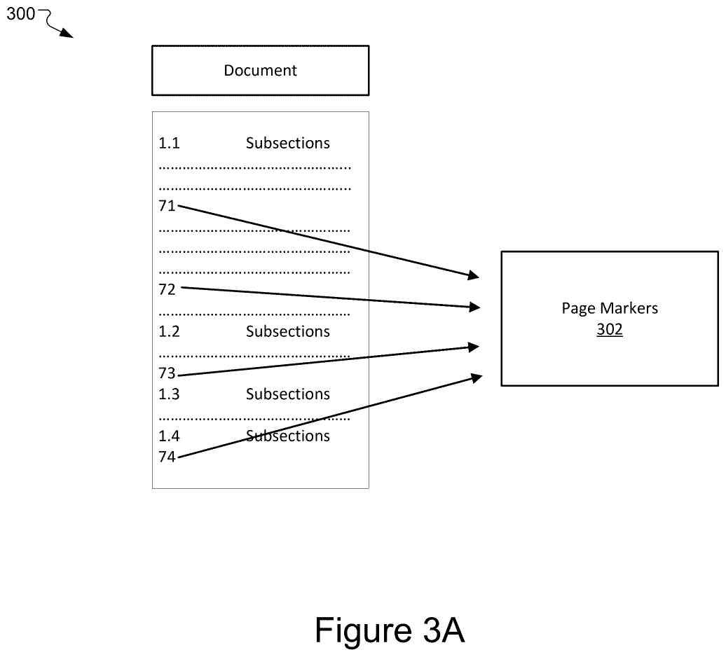

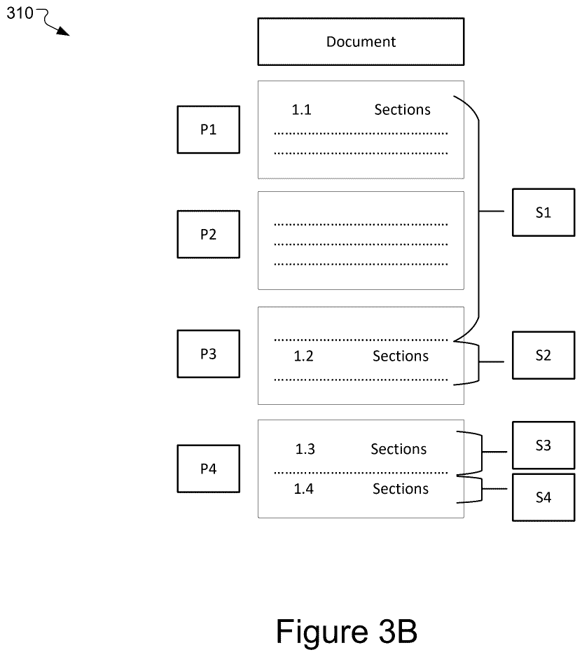

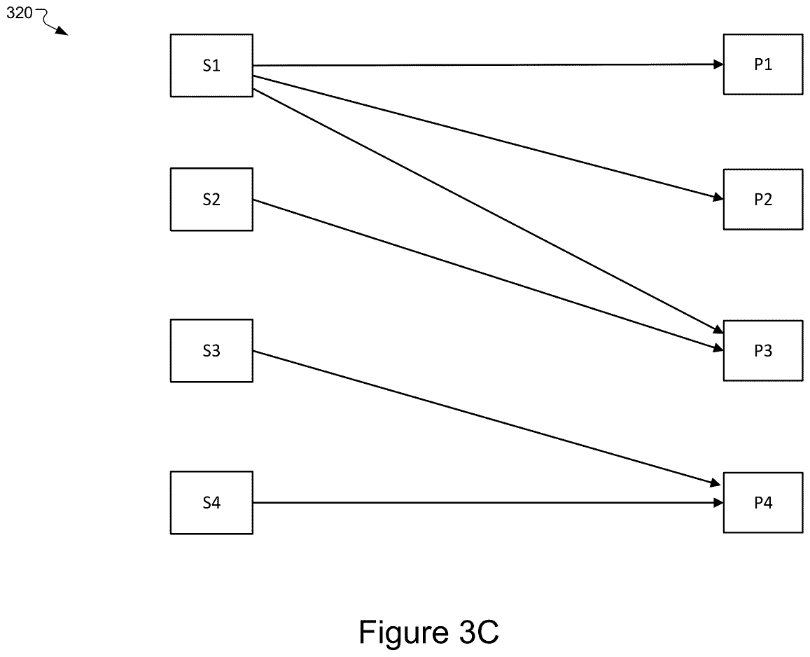

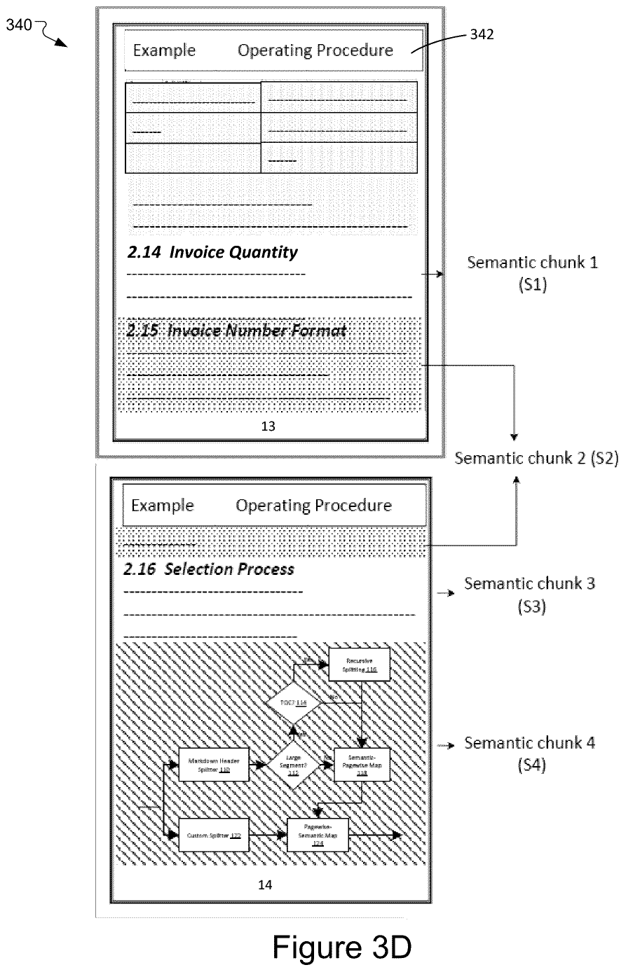

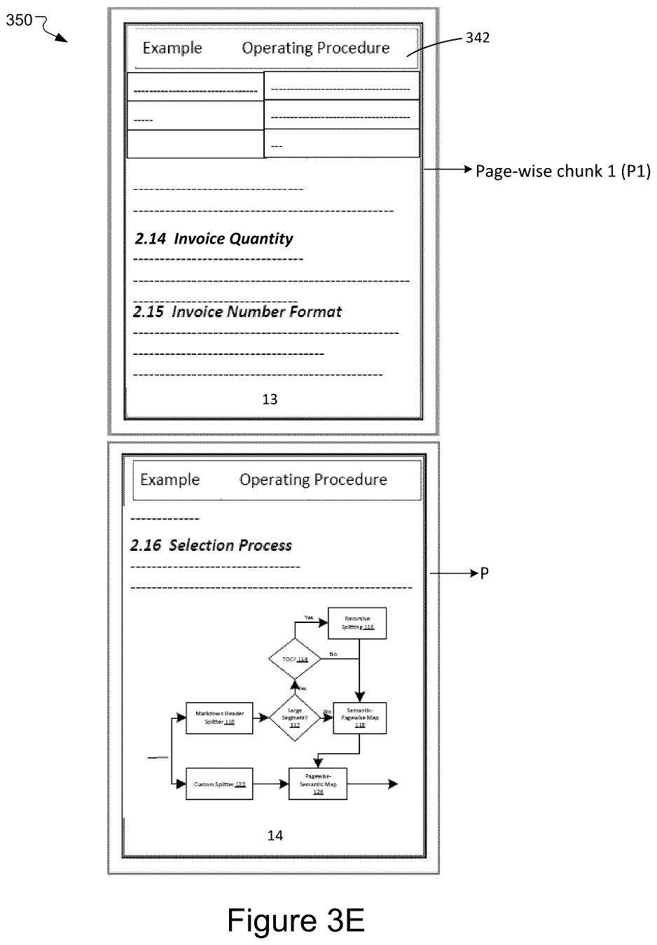

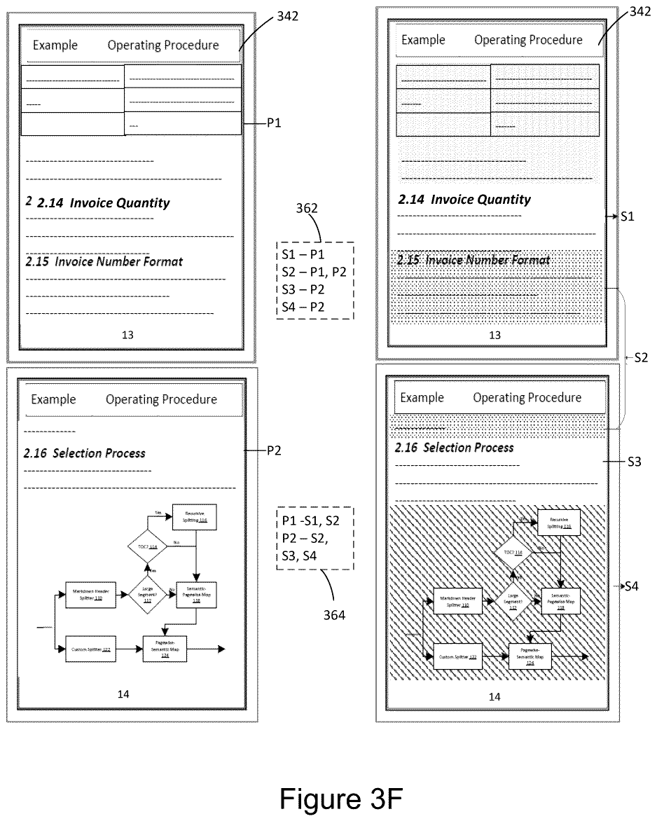

After the creation of semantic segments at 110 and refinement at 116, to maintain structural integrity and organization of input document 102, the present system creates page markers between the markdown text of each page that correspond to the segments of content. These page markers are useful annotations that link semantic segments to specific page numbers, ensuring that when a segment is retrieved, the segment includes the correct page reference. This enhances context and facilitates navigation within a large document. The page markers can be used to create page-wise splitting at 118, where each semantic segment is mapped to one or more specific pages (as described below in FIG. 3A). This mapping is a structured representation that aligns semantic meaning with the document's page structure.

In some embodiments, custom splitter 122 may be employed to process input document 102, for example, when input document 102 lacks structural elements (e.g., headers). Customer splitter 122 uses page markers to divide input document 102 into unit-length chunks, with each chunk corresponding to a single page. The present system then performs page-wise semantic mapping in step 124 to map the unit-length chunks to semantic segments. Specifically, this mapping in 124 indicates which unit-length chunks are related to a semantic segment, which is inverted to identify which semantic segments are associated with each unit-length chunk as discussed above in steps 118 and 120. At step 126, the present system stores the unit-length chunks created in step 122, along with the mappings from step 124, in the metadata for each chunk, which are referred to as page-wise segments.

It should be noted that the relationship between semantic segments and page numbers may not be a direct one-to-one mapping. Because content distribution across pages varies, multiple semantic segments can be associated with a single page number. This reflects the inherent complexity of documents, where a section may span multiple pages, or multiple sections may exist within a single page. The semantic page-wise mapping 118 and the page-wise semantic mapping 124 will be further described below in FIGS. 3A-3D.

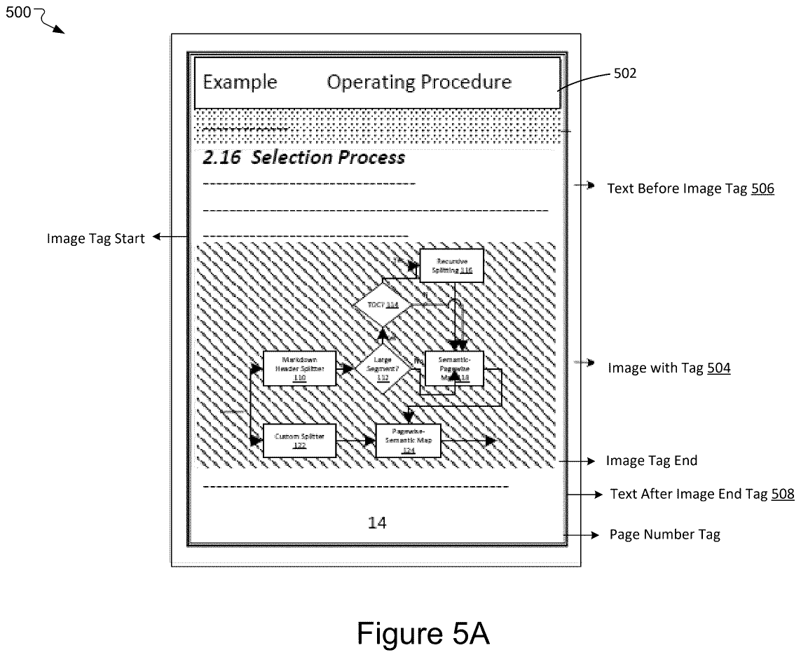

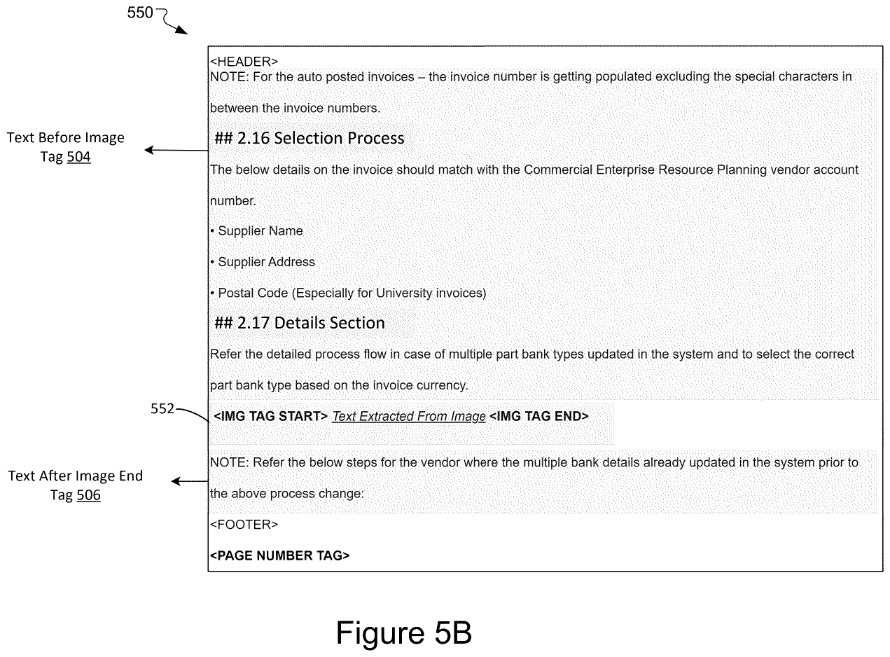

The present system may also separately generate image segments, which are portions of input document 102 that contain images, along with their associated metadata, captions, and relevant textual context. Referring again to FIG. 1A, in some embodiments, the present system may use an image processing system, referred to as image handler 128, to scan input document 102 and identify all embedded images, including figures, charts, and illustrations. For example, image handler 128 may receive page-wise text (e.g., in Adobe® portable document format (PDF)), identify an image in the text, and verify the image is valid and functional. The present system may then receive associated text to establish context (e.g., captions, surrounding content). Using the image semantic map 130, the present system may map each image to a relevant document section to maintain logical consistency. The resulting image segments 132 are not just isolated elements but are meaningfully connected to the corresponding textual content. The image segmentation will be further described below with reference to FIGS. 5A and 5B.

The generation of semantic segments 120, page-wise segments 126, and image segments 132 enhances the usability of documents, particularly for search, referencing, and knowledge extraction. The present system may organize and store segments and associated metadata (e.g., page number, header, context, etc.) in one or more indices 134, and an index helps locate the most relevant segment efficiently without scanning the entire document based on queries.

The present system may transform the text or image segments into an embedding model 134, where strings of text and/or image data are converted into numerical representations (e.g., vectors) that capture their semantic meaning through a well-defined function. Instead of searching by exact keywords, this transformation allows for more advanced search capabilities such as similarity-based retrieval, to generate context-aware results. For example, vectorization enables the application of a distance function that assesses the similarity between different sections, as represented by the vectors. By calculating the distance between elements within a matrix, the present system can prioritize and retrieve information that is most relevant to a given query based on semantic proximity. The present system uses index 134 and embedding model 136 together to improve accuracy and efficiency in retrieving relevant information from input document 102.

### Dynamic Thresholding

FIG. 1B illustrates an exemplary process for dynamic thresholding 150, which is used to determine the most relevant document segments to be retrieved based on user queries. The present system may create keywords 152 from the stored semantic segments 120 because keywords can be used for context-aware searches in addition to exact matches. For example, the present system may generate keywords based on query terms, document content, or metadata. The most relevant keywords can be associated with their respective document segments for quick look up during search queries. When a user enters a query, the present system can search the index 154 to determine the most relevant document segments based on keywords, embeddings, and relevance scores.

After the segments are formed and stored in a database for retrieval, the present system may employ a retrieval mechanism (Okapi BM25 in this case, similar methods can be applied to calculate threshold for various search methods, those in relevant fields will understand) to retrieve appropriate documents from the database in response to a user query. Each retrieved segment is given a relevance score by the retrieval mechanism and then filtered by the relevance score using a threshold, thereby preventing irrelevant data from being returned to the querying user.

As discussed above, the relevance score determined for a document may vary if a document corpus (e.g., a database) varies. When a static threshold is used to retain high-ranking documents, this threshold may become obsolete when a new document is added, or an existing one is removed from the corpus. The present system may calculate a dynamic threshold at 156 to adapt to the dynamic data corpus by re-calculating thresholds subsequent to a document addition or deletion in the database.

Suppose new document segments are denoted as Cᵢ. Once the segments are stored in the database, these segments can be queried, and threshold scores can be calculated. In some embodiments, document section headers are used as test queries to simulate ideal real user queries (i.e., replicate a user inquiry as closely as possible), ensuring realistic thresholds that allow for effective corpus-related queries in the segments.

Let Qᵢ={Qᵢ₁, Qᵢ₂, Qᵢ₃, . . . Qᵢₖ} be the k queries generated for a list of segments Ci. The present system may apply a retrieval algorithm (e.g., BM 25) to fetch document segments from the database based on the generated queries, for example, using a search relevance score assigned to each retrieved segment. For the i-th document and j-th query, where j ∈{1, 2, 3 . . . k}, a row matrix of M fetched segments can be defined as:

C_{1×M}=R(Qᵢⱼ),M∈

[symbol]

The corresponding relevance scores are stored in a matrix of the same dimension SM_{1×M}. The process is repeated for all queries in Qᵢ, leading to multiple score matrices:

$$\begin{matrix}{SM}_{1 \times M}^{1} = & [ {s}_{11} & {s}_{12} ⋯ & {s}_{1 m} ] \\ ⋮ & ⋮ & ⋮ & \\ {SM}_{1 \times M}^{k} = & [ {s}_{k 1} & {s}_{k 2} ⋯ & {s}_{km} ]\end{matrix}$$

Once the scores SM_{1×M} are determined, a threshold may be calculated. However, some queries may yield unusually high or low scores due to anomalies in the retrieval process. To remove these anomalies, an outlier detection algorithm may be applied. For example, if mⱼ are the outliers removed from each score matrix, the filtered score matrices are:

$$\begin{matrix}{SM}_{1 \times ( M - m 1 )}^{1} = & [ {s}_{11} & {s}_{12} ⋯ & {s}_{1 M - m 1} ] \\ ⋮ & ⋮ & ⋮ & \\ {SM}_{1 \times ( M - m k )}^{k} = & [ {s}_{k 1} & {s}_{k 2} ⋯ & {s}_{kM - m k} ]\end{matrix}$$

where the set of all filtered score matrices is represented as {SMⱼ}, j∈{1, 2, 3 . . . k}.

To identify stable threshold values, the present system computes the percentage change between consecutive scores within each matrix.

$$\begin{matrix}{PC\_SM}_{1 \times ( M - m 1 - 1 )}^{1} = & \frac{{s}_{11} - {s}_{12}}{{s}_{12}} & \frac{{s}_{12} - {s}_{13}}{{s}_{13}} ⋯ & \frac{{s}_{1 M - m 1 - 1} - {s}_{1 M - m 1}}{{s}_{1 M - m 1}} \\ ⋮ & ⋮ & ⋮ & ⋮ \\ {PC\_SM}_{1 \times ( M - m k - 1 )}^{k} = & \frac{{s}_{k 1} - {s}_{k 2}}{{s}_{k 2}} & \frac{{s}_{k 2} - {s}_{k 3}}{{s}_{k 3}} ⋯ & \frac{{s}_{k M - m k - 1} - {s}_{k M - m k}}{{s}_{k M - m k}}\end{matrix}$$

where the set of all percentage change matrices is represented as {PC_{SMj}}, j∈{1, 2, 3 . . . k}.

To refine the threshold, the present system may trim all matrices in {SM} based on whether a percentage change exceeds a predefined value (e.g., 0.5) in the corresponding matrix in {PC_{SM}}. This ensures that only stable and consistent scores contribute to the final threshold calculation. In some embodiments, after trimming, the present system may calculate a mean score of each row matrix:

S̅M̅_̅{̅J̅}̅=mean(SM^{j}),j∈{1,2,3 . . . k}

and computer a final dynamic threshold by averaging across all the means:

Threshold=mean[S̅M̅ⱼ̅],∇j∈{1,2,3 . . . k}

A simplified example is described herein to summarize the above process. Suppose initial relevance scores

$$( e . g . , {SM}_{1 \times M}^{1} )$$

calculated for a proxy query “SAP Transaction Codes” are [1000, 100, 89, 56, 49, 30, 10]. The first score, 1000, is significantly greater than the other scores. While this score may be relevant to the query, it may skew the overall analysis, and the present system can remove it as an outlier. After this removal, the remaining scores (e.g.,

$$( e . g . , {SM}_{1 \times ( M - m 1 )}^{1} )$$

are [100, 89, 56, 49, 30, 10]. The present system can then identify significant drops. For example, the present system may determine a percentage change exceeding a predefined value (e.g., >50%) between consecutive scores, thereby identifying a large drop that may indicate an abrupt change in relevance. Here, because the change is greater than 50% from 30 to 10, the present system may determine to cut off the scores at 30. After this trimming using the predefined value, the remaining valid scores are [100, 89, 56, 49, 30]. The present system can then calculate the average of the remaining scores, i.e., S̅M̅_̅{̅J̅}̅=(100+89+56+49+30)/5=64.8, and this average, 64.8, is the threshold for the query “SAP Transaction Codes.”

The present system repeats the same process for multiple proxy queries. For each query, an individual respective threshold score is calculated. After calculating individual thresholds for all proxy queries, the present system may take the average of all these thresholds to get a final corpus threshold (Threshold=mean[S̅M̅_̅{̅J̅}̅]). This corpus threshold represents the overall relevance of the corpus of proxy queries.

The threshold, an individual threshold and/or the corpus threshold, may be dynamically updated when new documents are added or removed from the data corpus. Once this threshold is established, it is applied to filter out low-scoring retrieved segments during future queries. This ensures that only the most relevant document segments are retrieved for a given query. By eliminating anomalous scores that could distort search results and updating thresholds automatically as the data corpus changes, the present system can reduce noise and optimize retrieval speed and accuracy.

### Functional Workflow

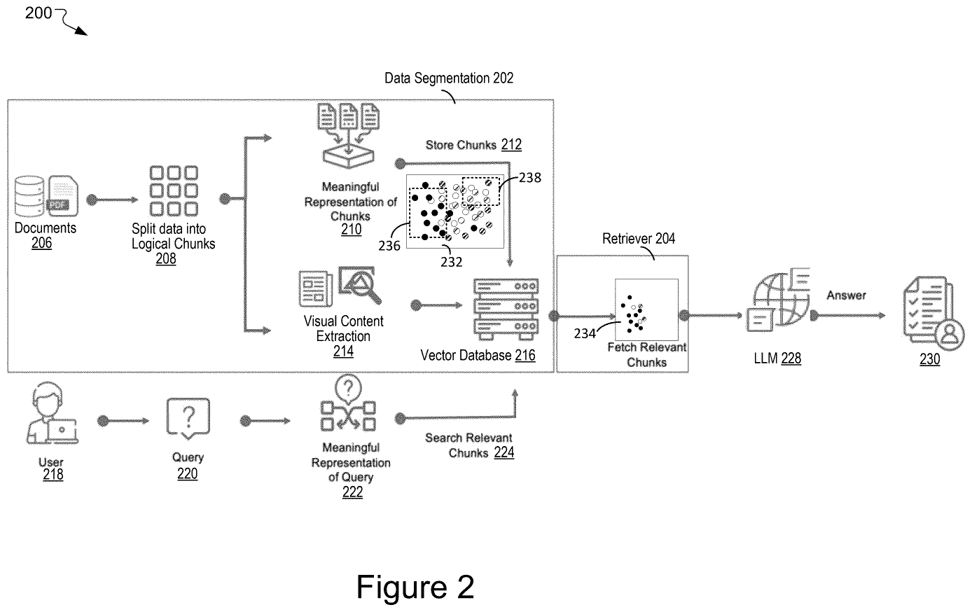

FIG. 2 illustrates an exemplary functional diagram 200 for segmenting and retrieving data, where a segmentation or chunking strategy is depicted in box 202 and a retriever is shown in box 204. In the example of FIG. 2, the core components (e.g., data segmentation 202 and retriever 204) are described in the context of a data retrieval use case, demonstrating how relevant segments are identified and further refined. This process minimizes or reduces the data volume while enhancing quality, ensuring that the input to an LLM model is more precise and structured, ultimately improving the model's performance.

It should be noted that the example described herein merely represents one use case. The refined data segments can be utilized in a wide range of applications for further processing, including summarization and content generation, data indexing and cataloging, anomaly detection and data quality assessment, semantic analysis and knowledge graphs, personalized recommendations, automated compliance and policy enforcement, efficient document translation, voice assistants and chatbots, as well as automated document generation and formatting, among others. For example, the refined and structured data segments allow better anomaly detection in documents, helping identify inconsistencies, formatting errors, or missing information.

Typically, a document undergoes processing and is divided into multiple semantic segments for storage in a database. This process includes large-segment handling based on one or more of TOC-based segment handling and page-wise segmenting. However, segment processing is not restricted to pre-storage operations and can also be dynamically triggered by specific applications. For example, when a user queries a database and a large language (LLM) model is employed to generate a comprehensive response, this data retrieval process may include segment processing, particularly large segment processing, to address context window limitations of the LLM model and improve the performance of the LLM model, ultimately improving the accuracy and efficiency of responses.

As depicted, when documents 206 are received, the present system may perform data segmentation 208 to transform documents 206 into logical data segments or chunks (e.g., semantic chunks). Documents 206 may include text (e.g., standard operating procedures (SOPs)), images, videos, audios, or other types of data. Data segmentation 208 may include markdown splitting, page-wise chunking, large semantic chunk handling, recursive splitting, etc., as discussed above in FIG. 1A. The document segmentation 208 may output meaningful representations of chunks 210 for storing in 212. The chunking strategy may also include extracting the visual content of documents 206 (e.g., using any suitable optical character recognition (OCR) service) in 214. The relationship between each extracted visual content and one or more segments is retained to ensure efficient and accurate data retrieval (as shown in image handling 128 of FIG. 1A). The segments along with the corresponding visual content are stored in a vector database 216. In some embodiments, semantic segments, page-wise segments, and image segments may be stored in vector database 216. The chunking strategy 202 is discussed above in FIG. 1A, and some of the distinct features, such as semantic page-wise chunking, TOC controlled chunking, and image handling, will be further described below with reference to FIGS. 3A-3F, 4A-4C, and 5A-5B.

Once segments or chunks are indexed and stored in vector database 216, these segments are ready for queries. When a search is performed, the present system may retrieve only the most relevant document segments based on semantic meaning and thresholding, ensuring faster, more accurate search results. In FIG. 2, when a user 218 sends out a query 220, the present system may generate a meaningful representation of query 220 (e.g., by capturing the semantic intent and context of query 220) and search vector database 216 for relevant chunks in 224. In particular, the present system may apply retriever 204 to fetch the most relevant chunks, which can be processed as required (e.g., which are input into a large language model to generate and output an accurate query result 230 to querying user 218). For example, the LLM model may generate a query result by processing the fetched chunks from retriever 204, determine the context and meaning of the chunks, and then generate relevant response(s) based on patterns the model has learned during training.

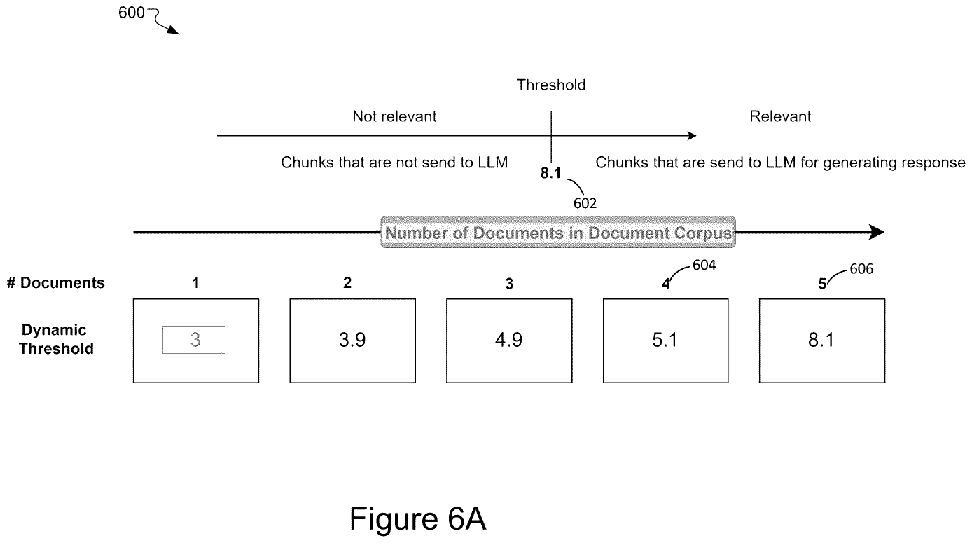

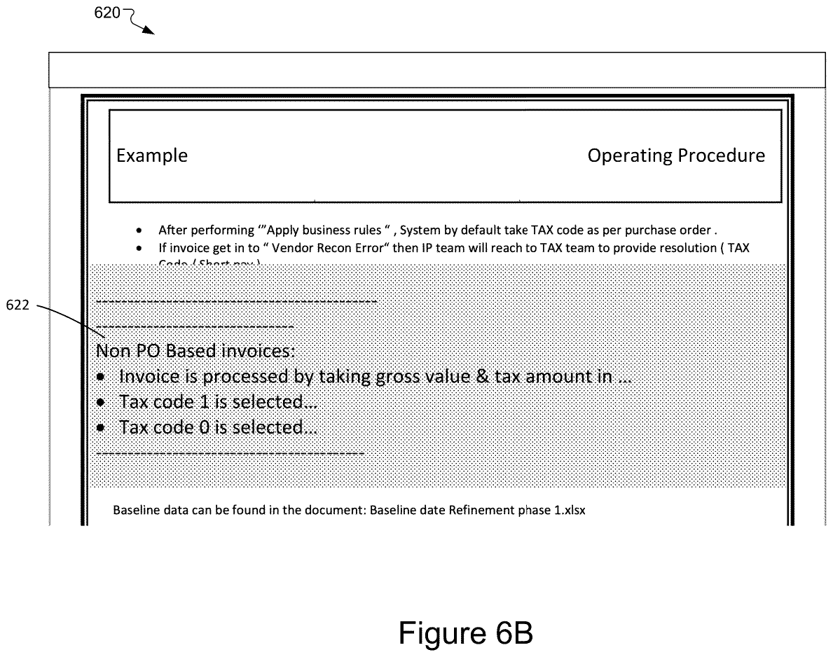

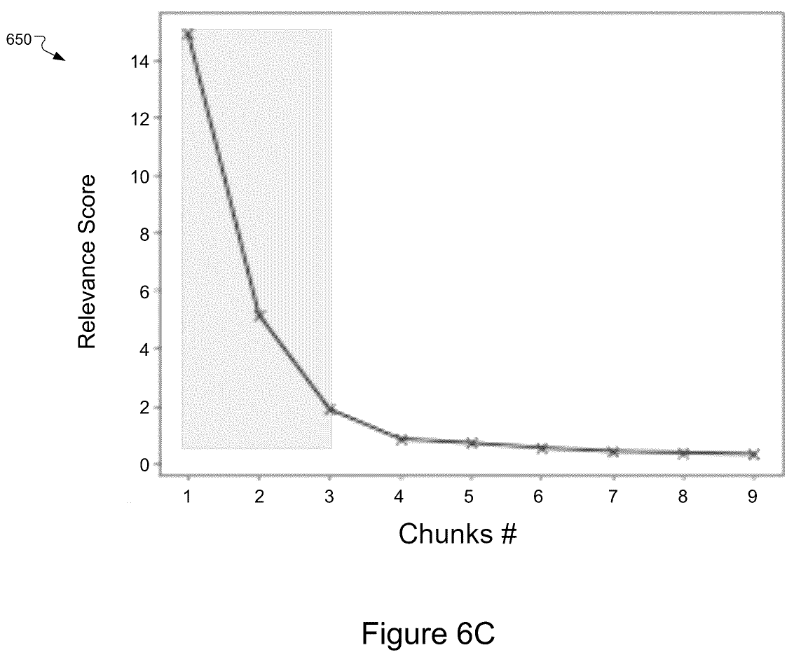

In the example of FIG. 2, based on the search of data corpus index 216, the present system may initially identify a first set of relevant semantic chunks for query and filter using dynamic thresholds at 220. Each segment/chunk in the first set is represented by a vector, as shown by the circle in 232. Before using the retriever chunks, it is checked if a large semantic chunk is present among the first set. When the first set of chunks is provided to LLM 228, it generates an appropriate query result or answer 230. However, the first set often includes too many chunks and/or large chunks, and this may negatively impact the performance of LLM 228, leading to suboptimal results. In such cases, retriever 204 is run on the unit-length chunks corpus by applying page filters using page-wise mapping stored in metadata of the retrieved large semantic chunks and then again filtered using dynamic thresholds. This process may be repeated until the relevant segments shown in 234 are sufficiently refined, allowing LLM 228 to generate an optimal result 230. In some embodiments, retriever 204 may intelligently determine the refined vector set of semantic segments using dynamic thresholding, reducing the search space (e.g., including large semantic chunks) and enhancing the retrieval efficiency and accuracy. The custom retrieval and dynamic thresholding will be further described below with reference to FIGS. 4A-4C and 6A-6C.

### Semantic Page-Wise Chunking

As shown above in FIGS. 1A and 2, the present system applies semantic processing to enhance the structure and ensure meaningful segmentation. This process (e.g., semantic page-wise chunking, image handling, etc.) can ensure that the content is not just split arbitrarily but is contextually optimized for retrieval and processing. In some embodiments, the present system may employ a semantic page-wise chunking component to improve the performance of existing segmentation techniques such as markdown splitter and structural index splitting like TOC splitting. This innovative semantic page-wise chunking component, shown as steps 118, 124 in FIG. 1A or part of step 208 in FIG. 2, is configured to associate each semantic segment with specific page numbers from an original document. This component creates a mapping that helps the present system track the origin of each segment within the document, facilitating reference and navigation. Once both the semantic segments and page-wise segments (e.g., 120 and 126 in FIG. 1A) are stored in the database, it becomes straightforward to navigate between the two segments.

As shown in representation 300 of FIG. 3A, the present system may add page markers 302 (e.g., page 71, page 72) to sections and subsection of a document, and use a custom splitter (e.g., 122) to create one or more unit-length chunks, i.e., page-wise segments for the document. FIG. 3B illustrates an exemplary representation 300 of semantic page-wise chunks. In this example, document 302 includes four pages, labeled P1, P2, P3, and P4. Whether a section is contained within a single page or spans across multiple pages, a segment (e.g., S1, S2, S3, and S4) may be created between two sections. For example, segment S1 covers section 1.1 across pages P1, P2, and P3, while segments S3 and S4 respectively representing sections 1.3 and 1.4 are located on the same page P4. Here, while a section header is considered as the boundary for a new segment, the present system is able to retain the context even if the content of the section spans multiple pages. Once this semantic & unit-length chunking is executed (e.g., as shown in steps 110, 116, 122 of FIG. 1A), a semantic-page mapping is performed using the page marker(s) added in the markdown document to associate each semantic segment with the specific pages in the original document it spans, which is particularly useful in large segment handling. A segment may span one or more pages, and a page may include one or more segments. The segment-pagewise mappings are depicted in representation 320 of FIG. 3C. For example, segment S1 maps to three pages P1, P2, and P3, while both segments S3 and S4 are located on the same page of P4.

The semantic page-wise chunking is detailed in another example of FIGS. 3D-3F. In representation 340 shown in FIG. 3D, the two-page content of an example operating procedure document 342 is split into four segments S1 through S4. Each semantic chunk starts at the beginning of a particular section (e.g., section 2.14) and end at the conclusion of that section, or alternatively, at the start of the next section (e.g., section 2.15). For example, segment S1 starts at section 2.14 and ends at section 2.15. Similarly, section 2.16 constitutes the third semantic chunk S3, and section 2.17 is the fourth semantic chunk S4.

When humans write or maintain knowledge, there is inherent contextual relevance tied to the section or heading titles. This is why sections are often considered semantically cohesive chunks. For example, section 2.15 “Invoice Number Format” represents a semantic chunk S2 that spans across two pages. However, in such cases, existing segmentation approaches (e.g., markdown splitters and recursive splitters) may fail because a portion of the information is located on the subsequent page, leading to incomplete or disjointed segmentation.

A representation 350 of FIG. 3E shows page-wise chunks P1 and P2 that are determined from the two-page content of the same operating procedure document 342. Each page-wise chunk contains the entire amount of information on a particular page. That is, the first page of document 342 is page-wise chunk P1, and the second page of document 342 is page-wise chunk P2.

Semantic pair-wise mappings between page-wise chunks (e.g., P1 and P2) and semantic chunks (e.g., S1, S2, S3, and S4) of the same document 342 are depicted in FIG. 3F. A semantic to page-wise mapping is shown in 362, where “S1-P1” indicates that S1 is located on the first page and corresponds to P1, “S2-P1, P2” indicates that S1 spans the first and second pages and aligns with both P1 and P2, etc. Advantageously, the present system has the capability to map a single semantic segment across multiple pages, preserving the contextual relationship and ensuring continuity of knowledge across pages (e.g., the knowledge on the second page).

The present system may also determine how many semantic chunks are present on one page, as shown by the page-wise semantic mapping in 364. “P1-S1, S2” signifies that two semantic chunks S1 and S2 are present on the first page. “P2-S2, S3, S4” indicates that the second page includes semantic chunks S2, S3, and S4 associated with corresponding demarcation headers. Using the mapping in 362 and 364, the present system not only identifies the page(s) where content is located but also retains information about the section (e.g., paragraph) the content belongs to. This enhances the referencing mechanism, enabling accurate tracking of the information's source (e.g., within a segment) and ensuring precise citations.

### Large Semantic Segment Breaking

A large segment (e.g., 112 in FIG. 1A) may occur in several scenarios. During markdown conversion (e.g., 110 in FIG. 1A), some headers may not be detected, leading to large text blocks being grouped together. Also, sections of a document may not be bound by length. If a document section spans multiple pages, a lack of clear breakpoints (e.g., identifiable headers) on some page(s) may result in the segment extending across more than one page. Moreover, dense content pages such as pages with long paragraphs, embedded tables, or continuous text may result in oversized segments.

Large segments are problematic when a LLM (e.g., 228 in FIG. 2) uses segmented text in retrieval-based systems to generate document-based query responses, because these segments tend to overwhelm the context window of the model, which is typically limited to a fixed number of tokens. When a segment is too large, the model may have to truncate important information, leading to incomplete or less accurate retrieval results. Furthermore, large segments often contain a mix of relevant and irrelevant information, making it harder for the LLM to focus on the most pertinent details. This reduces the precision of retrieved content, as the LLM struggles to identify and prioritize key information. Additionally, large segments increase computational overhead, resulting in slower response times and higher operational costs. Overall, smaller, more focused segments allow the LLM to operate more efficiently, improve retrieval accuracy, and provide more relevant and context-aware results.

When detecting a large segment, the present system may apply additional processing such as steps 112, 114, and 116 of FIG. 1A. If a content outline or document index such as TOC is available, the present system may cross-reference the TOC to identify possible section breaks (e.g., headers) within the large segment. This process is also described in FIGS. 4A and 4B.

### TOC-Controlled Chunks

The present system can refine segments based on a document's content outline TOC guide, for example, by using the TOC as a navigation guide to ensure that each segment aligns with the document's logical organization, potentially redefining initial segments to better capture the document's structure.

As shown in representation 400 in FIG. 4A, the example operating procedure document 342 includes a table of contents (TOC) 402. While TOC 402 provides all the correct formatting information, it cannot prevent other formatting issues (e.g., caused by human errors). For example, header 404 (section 2.14) is correctly formatted, but header 406 (section 2.15) has an incorrect format. In entry 406 of section 2.15, “Invoice Number Format” is written as part of a running text rather than as a properly formatted header, failing to signal the start of a new section. For example, ideally, the markdown representation of document 342 should have been preceded by two hashtags to indicate the new section 2.15. However, due to the formatting error in 406, section 2.15 becomes incorrectly grouped with section 2.14, which could lead to inaccurate chunking (e.g., a large segment). To overcome this, the present system integrates a mechanism that cross-checks the structure of document 342 against the TOC 402. As a result, despite the formatting mistake I 406, the present system can determine that the content in 406 of section 2.15 matches a TOC entry 408 perfectly, allowing the system to logically split the content between sections 2.14 and 2.15.

By integrating TOC 404, the present system is able to circumvent errors and ensure accurate segmentation. This process helps cross-reference the document's structure with TOC, ensuring that semantic chunks are identified correctly, even in the presence of formatting issues.

### Reduced Search Space for Large Semantic Chunk

A navigation guide (e.g., Table of Contents) is not always available, and formatting issues may still occur, causing large segments. Referring to FIG. 4B, document 342 shown in representation 420 does not include a TOC. When no TOC is present, in some embodiments, the present system may construct semantic chunks based on markdown formats. In this example, section 2.15, “Invoice Number Format” in 422 is not a properly formatted header (as shown in 406 of FIG. 4A). Without the TOC-guided segmenting, sections 2.14 and 2.15 are grouped together as a single segment, represented by a box 424. If section 2.5 spans across multiple pages (e.g., four or five pages), the segment associated with sections 2.14 and 2.15 may become an over-sized segment, and such a large segment may incur more computation and not be as concise. In such scenarios (e.g., markdown headers exist but are not well-structured), the present system may reassess and refine the segmentation.

In some embodiments, the present system utilizes page mappings to avoid large semantic segments that could be cumbersome for data processing. For a given query Q, a retrieval mechanism R (e.g., Okapi BM25) may retrieve n relevant semantic segments:

R(Q)={SC}={SC₁,SC₂, . . . SCₙ} for an i∈{1,2,3 . . . Z}

If one of these segments (e.g., SCᵢ) is too large for efficient processing, the present system may use page mapping. Each semantic chunk SCᵢ is associated with a set of page numbers {p}ᵢ, which indicate the pages the chunk spans in the original document. The present system may then perform a retrieval on the page segments by applying filters based on the page numbers {p}ᵢ:

R(Q,filters)={P}, where {P} are the relevant page segments for query Q.

The large semantic segment SCᵢ is then replaced with these smaller page segments {P}, and the resulting set of smaller segments, along with other retrieved segments, can be used for further processing. This recursive approach reduces the computational load by focusing on smaller, page-specific segments while retaining the relevant context.

The above large segment processing using page mappings is also illustrated in an exemplary flow diagram 450 of a custom retriever in FIG. 4C, according to some embodiments. Process 450 starts when a user query is received at 452. This query may be in natural language (e.g., asking for specific information) or more structured (e.g., keywords). Responsive to receiving the user query, the present system applies filters at 454, i.e., a retrieval mechanism (e.g., Okapi BM25) or other algorithms designed for information retrieval. In some embodiments, the filters are used to search through a document corpus (including segments indexed and stored in a vector database) and score each semantic segment based on its relevance to the received query.

At step 458, the present system evaluates the size and relevance of the retrieved semantic segments. For example, if a segment is too large (e.g., spanning multiple pages), this segment may be marked as undesirable for further processing at steps 462 and 464. If the segment contains irrelevant information or is too broad, it may need to be split or refined at step 460, for example, by reordering long context.

If it is determined that a large segment exists at 458, the present system may fetch the pages mapped to the topmost or largest chunk at 462, using the semantic-pagewise mapping stored in semantic segment's metadata and then switch to a page-wise index and apply a filtering mechanism on the fetched pages at 464. Using this filtering mechanism, the present system may retrieve only the relevant page segments. These page segments represent smaller, more focused portions of the original large segment determined at 458. The retrieval result set includes these smaller page segments, which replace the original large segment.

An intuitive example, demonstrating how large segments are processed and how a search space is effectively reduced, is illustrated in the functional diagram 200 shown in FIG. 2. Referring back to FIG. 2, a first set of segments 232 is initially retrieved in response to receiving a user query 220. Suppose this first set includes at least a large segment, which would lead to significant computational overhead and cannot be passed onto for processing by LLM 228 (e.g., due to context window limitations).

### Image Handler

In some embodiments, the present system may perform image segmentation separately for non-textual content (e.g., tables, code blocks, or images) contained in a document. The present system may extract and validate text associated with images, such as metadata, captions, relevant textual context, etc. Specifically, the present system links images to their relevant text segments to preserve contextual meaning, which is mentioned above with respect to steps 128, 130, and 132 in FIG. 1A.

FIGS. 5A and 5B illustrate an exemplary image segmentation process. The present system may process document 502 and detect non-textual content in the document. The non-textual content may be converted into text (e.g., through any suitable OCR service) during a segmentation process. Advantageously, when an image is detected at a particular location of document 502, the present system ensures that the converted text is placed to be in the exact same position.

The present system may define or outline the boundaries of specific regions or objects around the image (e.g., above and below the image) with demarcation markers or tags in the original data (e.g., an electronic document), as shown in representation 500 of FIG. 5A. For example, the present system may tag an image included in a document 502 located at 504, and then identify the textual content around the image (e.g., “text before image tag” 506, “text after image end tag” 508, etc.). In some embodiments, the present system may identify the textual content by comparing the document that includes tagged images and a markdown output of the document that includes converted image text. FIG. 5B includes a markdown output 550 of document 502, which is used by the present system (e.g., image handler 128 in FIG. 1A) to construct semantic chunks. For example, text from section 2.17 may be selected by the present system to create the text before image tag 504 due to its proximity to the image. Based on the tags (e.g., text before image tag 504, text after image end tag 506, etc.,) associated with document 502, the present system may place the text extracted from the image at location 552, which is the exact same position as shown in FIG. 5A. In this way, the present system is able to correctly position visual content (e.g., between two specific tags within a specific page) with appropriate context meaning, ensuring consistent, accurate semantic segments.

### Dynamic Thresholding

In some embodiments, when retrieving data in response to a user query, the present system may compute a relevance score for the data corpus and identify a relevant segment by ranking the relevance scores against a threshold value. Dynamic thresholding is a useful mechanism in the process of data retrieval. This mechanism allows the present system to dynamically adjust the threshold for selecting relevant segments based on a query and a current state of a database. This ensures that a retrieval process remains effective when a document corpus changes, maintaining high relevance and accuracy in retrieval results. Through dynamic thresholding and using the data prepared by other components (e.g., semantic segmenting, large segment handling) to fine-tune the retrieval process, the present system can ensure that the most relevant and contextually appropriate segments are selected for any given query. Dynamic thresholding helps improve the system's adaptability and precision.

Referring again to FIG. 2, circles of segments (e.g., 234) may be identified and extracted from vector database 216 in response to receiving a query. FIG. 6A illustrates an exemplary representation 600 for dynamic thresholding. In this example, only those chunks having a score higher than the threshold of 8.1 (at 602) are filtered through and used further (e.g., used by a LLM model to generate a query response).

In some embodiments, the present system applies a ranking function (e.g., an Okapi-BM25 function) to compute a relevance score (e.g., a BM25 score) for each segment to qualify how well a segment matches a query. The higher the score, the more likely a segment is considered relevant to the query.

$$BM25 score ( D , Q ) = {\sum }_{i = 1}^{n} ln ( \frac{N - n ( {q}_{i} ) + 0.5}{n ( {q}_{i} ) + 0.5} + 1 ) \cdot \frac{f ( {q}_{i} , D ) \cdot ( {k}_{1} + 1 )}{f ( {q}_{i} , D ) + {k}_{1} \cdot ( 1 - b + b \cdot \frac{\vert D \vert}{avg dl} )}$$

It should be noted that the calculation of this score is related to a number of documents N included in a document corpus. The score increases as N increases in the document corpus, and the score decreases as N decreases in the document corpus, leading to inconsistent retrieval results when documents are added to or deleted from the document corpus. If the document corpus continues to change but the threshold is not adjusted, irrelevant, suboptimal chunks may be retrieved.

In some embodiments, the present system dynamically adjusts a threshold in real-time. Each time a document is added, deleted, or updated in the document corpus, the present system determines a new threshold. A proxy query may be randomly chosen from the section headers of randomly selected documents in the document corpus. For example, a proxy query may be posted, for which the present system knows the answer to the query is contained within content 622 of document 620 in FIG. 6B.

Upon receiving the proxy query, the present system retrieves document chunks (e.g., semantic chunks) based on relevance scores (e.g., BM25 scores) associated with the chunks. In the second step, the present system may determine an inflection point by analyzing the rate of change in the relevance scores and determining where the scores begin to level off. The most relevant chunks or top chunks are identified as those appearing before this inflection point. This inflection point marks the transition where the relevance scores start to decline. For example, as illustrated in representation 650 of FIG. 6C, the system may determine that the first three chunks are the most relevant. In the third step, the present system may calculate the average relevance score of these top chunks.

The present system may repeat the above three steps for multiple proxy queries (e.g., 10 queries) and take the average score across all the relevance scores associated with the multiple proxy queries. Each time when the document corpus varies with a new or removed document, an average relevance score is calculated (e.g., using the above three steps), and a new threshold is determined. For example, as shown in FIG. 6A, when the document corpus size increases from four to five (e.g., at 604 and 606), the present system determines that the threshold is changed from 5.1 to 8.1.

### Flowchart

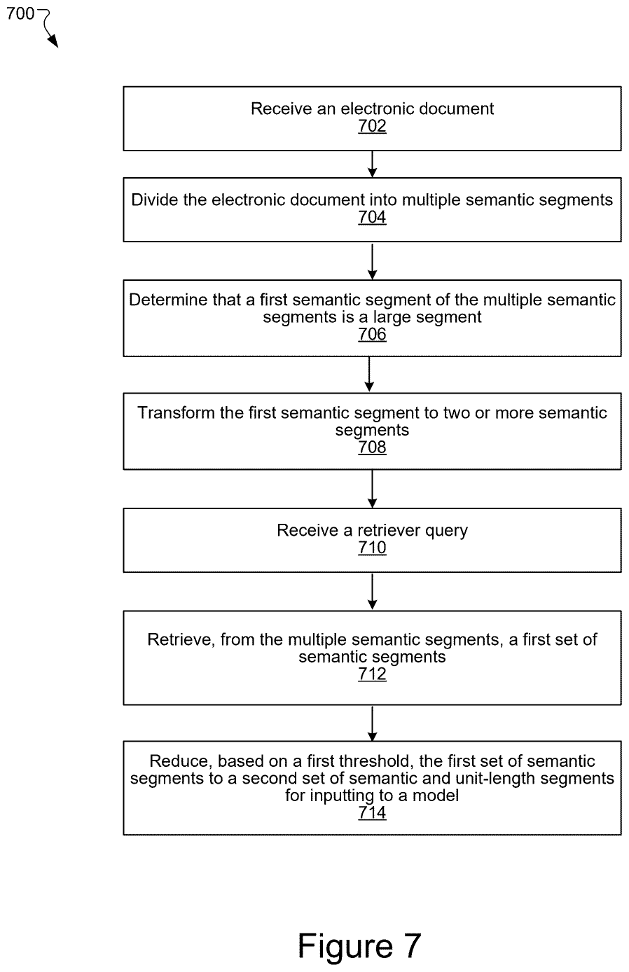

FIG. 7 illustrates a flowchart 700 of generating semantic segments for data retrieval based on a dynamic threshold, according to some embodiments. At step 702, the present system may receive an electronic document. The document may include text data and non-textual data such as tables, figures, images, etc. At step 704, the present system may divide the electronic document into multiple semantic segments for storing in a database. In some embodiments, the present system may segment the document based on one or more section headings and perform semantic page-wise mapping. Prior to the document segmentation, the present system may perform demarcation identification to determine the section headings. Once the section headers are identified, the present system may use a markdown header splitter to determine the semantic segments. The present system may determine that a first semantic segment of the multiple semantic segments is a large segment at step 706 and transform the first semantic segment into two or more semantic segments at step 708. The multiple segments including the two or more semantic segments are stored in a database. In some embodiments, if a large semantic segment is formed (e.g., due to poor header identification in the markdown conversion), the present system may use the table of contents to further refine these segments. The semantic page-wise mapping is also performed to map the semantic segments to the original pages of the document.

The present system may receive a query at step 710, and in response, retrieve, from the multiple semantic segments stored in the database, a first set of semantic segments at step 712. The first set includes the segments that are initially determined to be relevant to the query.

At step 714, the present system may reduce, based on a first threshold, the first set of semantic segments to a second set of semantic and unit-length segments, meaning that the less relevant segments (e.g., having a relevance score less than the first threshold) are also removed and the resultant set of segments is returned. The retrieved segments can be used as input to a model (e.g., LLM) for further processing (e.g., generating a query response).

### Example Use Cases

Disclosed herein is an innovative approach that incorporates semantic comprehension into data segmentation when processing the data in response to a query and leverages a dynamic scoring mechanism to filter queried information. The present system balances the need for context preservation with the requirement for accurate reference management. By employing a sophisticated algorithm that dynamically adjusts the splitting strategy based on the nature of the data (e.g., text) and its intended use, the present system can ensure that each data segment is both meaningful and contextually integrated, regardless of its length or complexity. The present system also incorporates an advanced referencing mechanism that accurately tracks the source of information (e.g., in a segment), allowing for precise citations even when the text is semantically split. As such, the present approach not only enhances the quality and coherence of the generated content but also ensures that references and citations are accurately and efficiently managed, addressing a critical gap in the existing technology.

Moreover, the present system integrates advanced processing techniques with a threshold-based mechanism to enhance search capabilities. By leveraging a dynamic scoring mechanism for filtering queried information, the present system can enhance relevance scoring and generate contextually relevant query results. This dynamic scoring mechanism dynamic scoring helps ranking even in a varying corpus.

This approach significantly improves the efficiency, quality, and consistency of retrieved data, making it particularly useful in sectors that require high standards of informational accuracy and contextual relevance.

One example use case is Cora Knowledge Assist (CKA) provided by Genpact. The present system may enhance CKA by significantly improving the retrieval of information from SOP documents. This application is tailored for entities (e.g., organizations) to efficiently query their vast SOP repositories, enabling users to quickly find precise operational guidelines, procedures, and practices. Documents are broken down into semantic segments, which are used for response generation for a user query related to an SOP document. The present system also uses page-wise mapping to fetch relevant sources for a query response.

The present system may also be employed in multimodal retrieval-augmented generation (RAG). The present system supports content creation by integrating and retrieving information across text, images, audio, and videos, enriching a creative process. The semantic chunking in videos, implemented by the present system, includes segmenting video content into meaningful pieces or chunks based on the semantics or the inherent meaning within the content. For example, by breaking down videos into semantically meaningful chunks, the present system may quickly retrieve specific segments relevant to a user query, enhancing the efficiency of content delivery. The present system may also enhance content generation because semantic chunks provide a rich, context-aware foundation for generating new content or augmenting existing content, ensuring the generated material is both relevant and coherent. The present system may further improve content organization in that it aids in organizing video content more logically, making it easier to manage, search through, and reference, thereby improving the overall user experience. Additionally, in the present system, a long video can be broken into smaller videos (e.g., an hour-long video is broken into several minute-long videos). A retriever can then be used to fetch accurate segments for a query. This helps reduce processing power and achieve more accurate responses.

The present system, when applied to index searches in online libraries and databases, may significantly enhance the speed and precision of information retrieval. By understanding and categorizing content based on its inherent meaning, semantic segmentation described herein ensures that search results are not only more accurate but also more relevant to a user query. This improves efficiency by quickly finding the right information and making the entire process of searching through vast online repositories more user-friendly and effective.

### Additional Consideration

In some examples, some or all of the processing described above can be carried out on a personal computing device, on one or more centralized computing devices, or via cloud-based processing by one or more servers. Some types of processing can occur on one device and other types of processing can occur on another device. Some or all of the data described above can be stored on a personal computing device, in data storage hosted on one or more centralized computing devices, and/or via cloud-based storage. Some data can be stored in one location and other data can be stored in another location. In some examples, quantum computing can be used, and/or functional programming languages can be used. Electrical memory, such as flash-based memory, can be used.

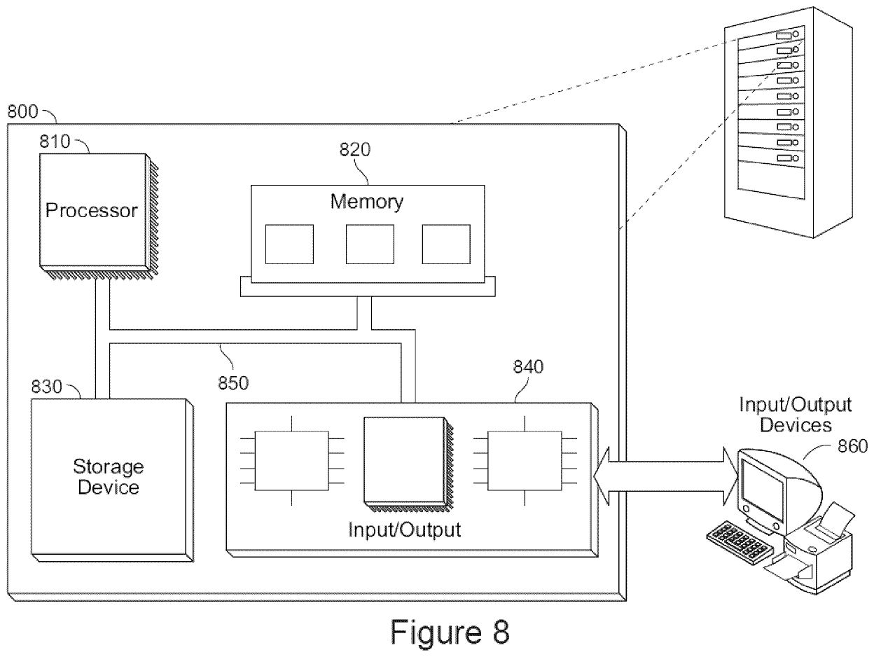

FIG. 8 is a block diagram of an example computer system 800 that may be used in implementing the technology described herein. General-purpose computers, network appliances, mobile devices, or other electronic systems may also include at least portions of the system 800. The system 800 includes a processor 810, a memory 820, a storage device 830, and an input/output device 840. Each of the components 810, 820, 830, and 840 may be interconnected, for example, using a system bus 850. The processor 810 is capable of processing instructions for execution within the system 800. In some implementations, the processor 810 is single-threaded. In some implementations, the processor 810 is a multi-threaded processor. The processor 810 is capable of processing instructions stored in the memory 820 or on the storage device 830.

Memory 820 stores information within the system 800. In some implementations, the memory 820 is a non-transitory computer-readable medium. In some implementations, the memory 820 is a volatile memory unit. In some implementations, the memory 820 is a non-volatile memory unit.

The storage device 830 is capable of providing mass storage for the system 800. In some implementations, the storage device 830 is a non-transitory computer-readable medium. In various implementations, the storage device 830 may include, for example, a hard disk device, an optical disk device, a solid-state drive, a flash drive, or some other large-capacity storage device. For example, the storage device may store long-term data (e.g., database data, file system data, etc.). The input/output device 840 provides input/output operations for the system 800. In some implementations, the input/output device 840 may include one or more network interface devices, e.g., an Ethernet card, a serial communication device, e.g., an RS-232 port, and/or a wireless interface device, e.g., an 802.11 card, a 3G wireless modem, or a 4G wireless modem. In some implementations, the input/output device may include driver devices configured to receive input data and send output data to other input/output devices, e.g., keyboard, printer, and display devices 860. In some examples, mobile computing devices, mobile communication devices, and other devices may be used.

In some implementations, at least a portion of the approaches described above may be realized by instructions that upon execution cause one or more processing devices to carry out the processes and functions described above. Such instructions may include, for example, interpreted instructions such as script instructions, executable code, or other instructions stored in a non-transitory computer-readable medium. The storage device 830 may be implemented in a distributed way over a network, such as a server farm or a set of widely distributed servers, or may be implemented in a single computing device.

Although an example processing system has been described in FIG. 8, embodiments of the subject matter, functional operations, and processes described in this specification can be implemented in other types of digital electronic circuitry, in tangibly embodied computer software or firmware, in computer hardware, including the structures disclosed in this specification and their structural equivalents, or in combinations of one or more of them. Embodiments of the subject matter described in this specification can be implemented as one or more computer programs, i.e., one or more modules of computer program instructions encoded on a tangible nonvolatile program carrier for execution by, or to control the operation of, data processing apparatus. Alternatively or in addition, the program instructions can be encoded on an artificially generated propagated signal, e.g., a machine-generated electrical, optical, or electromagnetic signal that is generated to encode information for transmission to a suitable receiver apparatus for execution by a data processing apparatus. The computer storage medium can be a machine-readable storage device, a machine-readable storage substrate, a random or serial access memory device, or a combination of one or more of them.

The term “system” may encompass all kinds of apparatus, devices, and machines for processing data, including by way of example a programmable processor, a computer, or multiple processors or computers. A processing system may include special-purpose logic circuitry, e.g., an FPGA (field programmable gate array) or an ASIC (application-specific integrated circuit). A processing system may include, in addition to hardware, code that creates an execution environment for the computer program in question, e.g., code that constitutes processor firmware, a protocol stack, a database management system, an operating system, or a combination of one or more of them.

A computer program (which may also be referred to or described as a program, software, a software application, a module, a software module, a script, or code) can be written in any form of programming language, including compiled or interpreted languages, or declarative or procedural languages, and it can be deployed in any form, including as a standalone program or as a module, component, subroutine, or other unit suitable for use in a computing environment. A computer program may, but need not, correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program can be deployed to be executed on one computer or on multiple computers that are located at one site or distributed across multiple sites and interconnected by a communication network.

The processes and logic flows described in this specification can be performed by one or more programmable computers executing one or more computer programs to perform functions by operating on input data and generating output. The processes and logic flows can also be performed by, and apparatus can also be implemented as, special purpose logic circuitry, e.g., an FPGA (field programmable gate array) or an ASIC (application-specific integrated circuit).

Computers suitable for the execution of a computer program can include, by way of example, general or special purpose microprocessors or both, or any other kind of central processing unit. Generally, a central processing unit will receive instructions and data from a read-only memory, a random access memory, or both. A computer generally includes a central processing unit for performing or executing instructions and one or more memory devices for storing instructions and data. Generally, a computer will also include, or be operatively coupled to receive data from or transfer data to, or both, one or more mass storage devices for storing data, e.g., magnetic, magneto-optical disks, or optical disks. However, a computer need not have such devices. Moreover, a computer can be embedded in another device, e.g., a mobile telephone, a personal digital assistant (PDA), a mobile audio or video player, a game console, a Global Positioning System (GPS) receiver, or a portable storage device (e.g., a universal serial bus (USB) flash drive), to name just a few.

Computer-readable media suitable for storing computer program instructions and data include all forms of non-volatile memory, media, and memory devices, including way of example semiconductor memory devices, e.g., EPROM, EEPROM, and flash memory devices; magnetic disks, e.g., internal hard disks or removable disks; magneto-optical disks; and CD-ROM and DVD-ROM disks. The processor and the memory can be supplemented by, or incorporated in special-purpose logic circuitry.

To provide for interaction with a user, embodiments of the subject matter described in this specification can be implemented on a computer having a display device, e.g., a CRT (cathode ray tube) or LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's user device in response to requests received from the web browser.

Embodiments of the subject matter described in this specification can be implemented in a computing system that includes a back-end component, e.g., as a data server, or that includes a middleware component, e.g., an application server, or that includes a front-end component, e.g., a client computer having a graphical user interface or a Web browser through which a user can interact with an implementation of the subject matter described in this specification, or any combination of one or more such back end, middleware, or front end components. The components of the system can be interconnected by any form or medium of digital data communication, e.g., a communication network. Examples of communication networks include a local area network (“LAN”) and a wide area network (“WAN”), e.g., the Internet.

The computing system can include clients and servers. A client and server are generally remote from each other and typically interact through a communication network. The relationship between client and server arises by virtue of computer programs running on the respective computers and having a client-server relationship with each other.

While this specification contains many specific implementation details, these should not be construed as limitations on the scope of what may be claimed, but rather as descriptions of features that may be specific to particular embodiments. Certain features that are described in this specification in the context of separate embodiments can also be implemented in combination in a single embodiment. Conversely, various features that are described in the context of a single embodiment can also be implemented in multiple embodiments separately or in any suitable sub-combination. Moreover, although features may be described above as acting in certain combinations and even initially claimed as such, one or more features from a claimed combination can in some cases be excised from the combination, and the claimed combination may be directed to a sub-combination or variation of a sub-combination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the embodiments described above should not be understood as requiring such separation in all embodiments, and it should be understood that the described program components and systems can generally be integrated together in a single software product or packaged into multiple software products.

Particular embodiments of the subject matter have been described. Other embodiments are within the scope of the following claims. For example, the actions recited in the claims can be performed in a different order and still achieve desirable results. As one example, the processes depicted in the accompanying figures do not necessarily require the particular order shown, or sequential order, to achieve desirable results. In certain implementations, multitasking and parallel processing may be advantageous. Other steps or stages may be provided, or steps or stages may be eliminated, from the described processes. Accordingly, other implementations are within the scope of the following claims.

### TERMINOLOGY

The phraseology and terminology used herein are for the purpose of description and should not be regarded as limiting.

The term “approximately”, the phrase “approximately equal to”, and other similar phrases, as used in the specification and the claims (e.g., “X has a value of approximately Y” or “X is approximately equal to Y”), should be understood to mean that one value (X) is within a predetermined range of another value (Y). The predetermined range may be plus or minus 20%, 10%, 5%, 3%, 1%, 0.1%, or less than 0.1%, unless otherwise indicated.

The indefinite articles “a” and “an,” as used in the specification and in the claims, unless clearly indicated to the contrary, should be understood to mean “at least one.” The phrase “and/or,” as used in the specification and in the claims, should be understood to mean “either or both” of the elements so conjoined, i.e., elements that are conjunctively present in some cases and disjunctively present in other cases. Multiple elements listed with “and/or” should be construed in the same fashion, i.e., “one or more” of the elements so conjoined. Other elements may optionally be present other than the elements specifically identified by the “and/or” clause, whether related or unrelated to those elements specifically identified. Thus, as a non-limiting example, a reference to “A and/or B”, when used in conjunction with open-ended language such as “comprising” can refer, in one embodiment, to A only (optionally including elements other than B); in another embodiment, to B only (optionally including elements other than A); in yet another embodiment, to both A and B (optionally including other elements); etc.

As used in the specification and in the claims, “or” should be understood to have the same meaning as “and/or” as defined above. For example, when separating data items in a list, “or” or “and/or” shall be interpreted as being inclusive, i.e., the inclusion of at least one, but also including more than one, of a number or list of elements, and, optionally, additional unlisted data items. Only terms clearly indicated to the contrary, such as “only one of or “exactly one of,” or, when used in the claims, “consisting of,” will refer to the inclusion of exactly one element of a number or list of elements. In general, the term “or” as used shall only be interpreted as indicating exclusive alternatives (i.e. “one or the other but not both”) when preceded by terms of exclusivity, such as “either,” “one of,” “only one of,” or “exactly one of” “Consisting essentially of,” when used in the claims, shall have its ordinary meaning as used in the field of patent law.

As used in the specification and in the claims, the phrase “at least one,” in reference to a list of one or more elements, should be understood to mean at least one element selected from any one or more of the elements in the list of elements, but not necessarily including at least one of each and every element specifically listed within the list of elements and not excluding any combinations of elements in the list of elements. This definition also allows that elements may optionally be present other than the elements specifically identified within the list of elements to which the phrase “at least one” refers, whether related or unrelated to those elements specifically identified. Thus, as a non-limiting example, “at least one of A and B” (or, equivalently, “at least one of A or B,” or, equivalently “at least one of A and/or B”) can refer, in one embodiment, to at least one, optionally including more than one, A, with no B present (and optionally including elements other than B); in another embodiment, to at least one, optionally including more than one, B, with no A present (and optionally including elements other than A); in yet another embodiment, to at least one, optionally including more than one, A, and at least one, optionally including more than one, B (and optionally including other elements); etc.

The use of “including,” “comprising,” “having,” “containing,” “involving,” and variations thereof, is meant to encompass the data items listed thereafter and additional data items.

Use of ordinal terms such as “first,” “second,” “third,” etc., in the claims to modify a claim element does not by itself connote any priority, precedence, or order of one claim element over another or the temporal order in which acts of a method are performed. Ordinal terms are used merely as labels to distinguish one claim element having a certain name from another element having a same name (but for use of the ordinal term), to distinguish the claim elements.

Each numerical value presented herein, for example, in a table, a chart, or a graph, is contemplated to represent a minimum value or a maximum value in a range for a corresponding parameter. Accordingly, when added to the claims, the numerical value provides express support for claiming the range, which may lie above or below the numerical value, in accordance with the teachings herein. Absent inclusion in the claims, each numerical value presented herein is not to be considered limiting in any regard.

The terms and expressions employed herein are used as terms and expressions of description and not of limitation, and there is no intention, in the use of such terms and expressions, of excluding any equivalents of the features shown and described or portions thereof. In addition, having described certain embodiments of the invention, it will be apparent to those of ordinary skill in the art that other embodiments incorporating the concepts disclosed herein may be used without departing from the spirit and scope of the invention. The features and functions of the various embodiments may be arranged in various combinations and permutations, and all are considered to be within the scope of the disclosed invention. Accordingly, the described embodiments are to be considered in all respects as only illustrative and not restrictive. Furthermore, the configurations, materials, and dimensions described herein are intended as illustrative and in no way limiting. Similarly, although physical explanations have been provided for explanatory purposes, there is no intent to be bound by any particular theory or mechanism, or to limit the claims in accordance therewith.

1. A computer-based method comprising:
receiving, at a computing system comprising a processor and a memory, an electronic document;
dividing, by the processor, the electronic document into a plurality of semantic segments;
determining, by the processor, that a first semantic segment of the plurality of semantic segments is a large segment;
transforming, by the processor, the first semantic segment into two or more semantic segments, each of the two or more semantic segments having a size less than the first semantic segment;
storing the plurality of semantic segments including the two or more semantic segments in a database;
receiving a query;
retrieving, by the processor and from the plurality of semantic segments stored in the database, a first set of semantic segments;
reducing, by the processor and based on a first threshold, the first set of semantic segments to a second set of semantic and unit-length segments for inputting to a model to generate a first retrieval response;
detecting a change of electronic documents in the database; and
reducing, by the processor and based on a second threshold, the first set of semantic segments to a third set of semantic and unit-length segments for inputting to the model to generate a second retrieval response, wherein the first threshold is different from the second threshold.

2. The method of claim 1, wherein transforming, by the processor, the first semantic segment into the two or more semantic segments comprises:
determining, by the processor, whether the electronic document includes a table of contents; and
in response to the table of contents being included in the electronic document, refining, by the processor, the first semantic segment using recursive splitting based on the table of contents.

3. The method of claim 1, wherein dividing, by the processor, the electronic document into the plurality of semantic segments comprises:
segmenting the electronic document based on one or more section headings; and
performing semantic page-wise mapping.

4. The method of claim 3, wherein the semantic page-wise mapping is performed by aligning and mapping the first semantic segment across one or more pages of the electronic document.

5. The method of claim 1, further comprising:
providing input to the model based on the query and the second set of semantic and unit-length segments, and obtaining, in response thereto, the first retrieval response as output from the model.

6. The method of claim 1, wherein detecting the change of electronic documents in the database comprises determining, by the processor, a second electronic document is added to or removed from the database, the method comprising:
computing, by the processor, the second threshold;
determining, by the processor, the third set of semantic segments from the first set of semantic segments using the second threshold; and
providing input to the model based on the third set of semantic segments and the query, and obtaining, in response thereto, the second retrieval response as output from the model.

7. The method of claim 6, wherein the first threshold and the second threshold are dynamically and automatically computed based on the change of the electronic documents in the database.

8. The method of claim 1, further comprising:
determining, by the processor, the electronic document includes non-textual content; and
performing, by the processor, segmentation on the non-textual content based on tagging the non-textual content and context surrounding the non-textual content.

9. The method of claim 8, wherein performing the segmentation on the non-textual content comprises:
processing, by the processor, the non-textual content that is included in the electronic document at a particular position of a particular page; and
inserting, by the processor, the processed non-textual content into one or more of the plurality of semantic segments at the particular position of the particular page based on the tagging.

10. A computing system comprising:
a processor; and
a memory in communication with the processor and comprising instructions which, when executed by the processor, program the processor to:
receive an electronic document;
divide the electronic document into a plurality of semantic segments;
determine that a first semantic segment of the plurality of semantic segments is a large segment;
transform the first semantic segment into two or more semantic segments, each of the two or more semantic segments having a size less than the first semantic segment;
store the plurality of semantic segments including the two or more semantic segments in a database;
receive a query;
retrieve, from the plurality of semantic segments, a first set of semantic segments;
reduce, based on a first threshold, the first set of semantic segments to a second set of semantic and unit-length segments for inputting to a model to generate a first retrieval response;
detect a change of electronic documents in the database; and
reduce, based on a second threshold, the first set of semantic segments to a third set of semantic and unit-length segments for inputting to the model to generate a second retrieval response, wherein the first threshold is different from the second threshold.

11. The system of claim 10, wherein, to transform the first semantic segment into the two or more semantic segments, the instructions further program the processor to:
determine whether the electronic document includes a table of contents; and
in response to the table of contents being included in the electronic document, refine the first semantic segment using recursive splitting based on the table of contents.

12. The system of claim 10, wherein, to divide the electronic document into the plurality of semantic segments, the instructions further program the processor to:
segment the electronic document based on one or more section headings; and
perform semantic page-wise mapping.

13. The system of claim 12, wherein the semantic page-wise mapping is performed by aligning and mapping the first semantic segment across one or more pages of the electronic document.

14. The system of claim 10, wherein the instructions further program the processor to:
provide input to the model based on the query and the second set of semantic and unit-length segments, and obtain, in response thereto, the first retrieval response as output from the model.

15. The system of claim 10, wherein the instructions further program the processor to:
detect the change of electronic documents in the database by determining a second electronic document is added to or removed from the database;
compute the second threshold;
determine the third set of semantic segments from the first set of semantic segments using the second threshold; and
provide input to the model based on the third set of semantic segments and the query, and obtain, in response thereto, the second retrieval response as output from the model.

16. The system of claim 15, wherein the first threshold and the second threshold are dynamically and automatically computed based on the change of the electronic documents in the database.

17. The system of claim 10, wherein the instructions further program the processor to:
determine the electronic document includes non-textual content; and
perform segmentation on the non-textual content based on tagging the non-textual content and context surrounding the non-textual content.

18. The system of claim 17, wherein, to perform the segmentation on the non-textual content, the instructions further program the processor to:
process the non-textual content that is included in the electronic document at a particular position of a particular page; and
insert the processed non-textual content into one or more of the plurality of semantic segments at the particular position of the particular page based on the tagging.

19. A computer program product comprising a non-transitory computer-readable medium having computer readable program code stored thereon, the computer readable program code configured to:
receive an electronic document;
divide the electronic document into a plurality of semantic segments;
determine that a first semantic segment of the plurality of semantic segments is a large segment;
transform the first semantic segment into two or more semantic segments, each of the two or more semantic segments having a size less than the first semantic segment;
store the plurality of semantic segments including the two or more semantic segments in a database;
receive a user query;
retrieve, from the plurality of semantic segments, a first set of semantic segments;
reduce, based on a first threshold, the first set of semantic segments to a second set of semantic and unit-length segments for inputting to a model to generate a first retrieval response;
detect a change of electronic documents in the database; and
reduce, based on a second threshold, the first set of semantic segments to a third set of semantic and unit-length segments for inputting to the model to generate a second retrieval response, wherein the first threshold is different from the second threshold.

20. The computer program product of claim 19, wherein, to transform the first semantic segment into the two or more semantic segments, the computer readable program code is further configured to:
determine whether the electronic document includes a table of contents; and
in response to the table of contents being included in the electronic document, refine the first semantic segment using recursive splitting based on the table of contents.
